(19) United States
(12) Patent Application Publication
(10) Pub. No.: US 2020/0236381 A1
(43) Pub. Date: Jul. 23, 2020

(54) VALUE LIMITING FILTER APPARATUS, VIDEO CODING APPARATUS, AND VIDEO DECODING APPARATUS

(71) Applicant: Sharp Kabushiki Kaisha, Sakai City, Osaka (JP)

(72) Inventors: Takeshi CHUJOH, Sakai City (JP); Tomohiro IKAI, Sakai City (JP); Tomoko AONO, Sakai City (JP); Tomonori HASHIMOTO, Sakai City (JP); Tianyang ZHOU, Sakai City (JP); Yukinobu YASUGI, Sakai City (JP)

(21) Appl. No.: 16/650,456

(22) PCT Filed: Sep. 21, 2018
(86) PCT No.: PCT/JP2018/035002

§ 371 Date: Mar. 25, 2020

(30) Foreign Application Priority Data
Sep. 28, 2017 (JP) 2017-189060
Mar. 29, 2018 (JP) 2018-065878
May 16, 2018 (JP) 2018-094933

(51) Int. Cl. H04N 19/44; H04N 19/117; H04N 19/186; H04N 19/635; H04N 19/124

(52) U.S. Cl. CPC H04N 19/45; H04N 19/117; H04N 19/124; H04N 19/635; H04N 19/186

(57) ABSTRACT

A value limiting filter includes a color space transform processing unit configured to transform an input image signal defined by a color space into an image signal of another color space, a clipping processing unit configured to perform processing of limiting a pixel value of the transformed image signal, and a color space inverse transform processing unit configured to transform the image signal having the limited pixel value into the image signal of the original color space.

### TECHNICAL FIELD

The present disclosure relates to a value limiting filter apparatus, and a video decoding apparatus and a video coding apparatus including the value limiting filter apparatus.

### BACKGROUND ART

A video coding apparatus which generates coded data by coding a video, and a video decoding apparatus which generates decoded images by decoding the coded data are used for efficient transmission or recording of videos.

For example, specific video coding schemes include schemes proposed in H.264/AVC and High-Efficiency Video Coding (HEVC), and the like.

In such a video coding scheme, images (pictures) constituting a video are managed in a hierarchical structure including slices obtained by splitting an image, coding tree units (CTUs) obtained by splitting a slice, units of coding (coding units; which will be referred to as CUs) obtained by splitting a coding tree unit, prediction units (PUs) which are blocks obtained by splitting a coding unit, and transform units (TUs), and are coded/decoded for each CU.

In such a video coding scheme, usually, a prediction image is generated based on a local decoded image that is obtained by coding/decoding an input image (a source image), and prediction residual components (which may be referred to also as “difference images” or “residual images”) obtained by subtracting the prediction image from the input image are coded. Generation methods of prediction images include an inter-picture prediction (an inter-prediction) and an intra-picture prediction (intra prediction).

In addition, NPL 1 is exemplified as a recent technique for video coding and decoding.

Other recent techniques for video coding and decoding include a technique called Adaptive Clipping Filter. In the technique, pixel values of each of Y, Cb, and Cr in a prediction image and a local decoded image are limited to a range defined by maximum values and minimum values of the pixel values of Y, Cb, and Cr in the input image signal for each picture. As a result, it can be seen that, in a case that there are pixels having pixel values outside the range, errors occur in the pixels. In a video coding apparatus and a video decoding apparatus employing Adaptive Clipping Filter, coding efficiency can be improved by modifying pixel values of pixels with errors.

### CITATION LIST

### Non Patent Literature

NPL 1: “Algorithm Description of Joint Exploration Test Model 7,” JVET-G1001, Joint Video Exploration Team (JVET) of ITU-T SG 16 WP 3 and ISO/IEC JTC 1/SC 29/WG 11, Aug. 19, 2017

### SUMMARY

### Technical Problem

However, even for a combination of pixel values that are not actually used in a YCbCr color space, the individual pixel values may be within the range of pixel values to be used. For this reason, there is room for further improvement in the coding efficiency of Adaptive Clipping Filter.

One aspect of the present disclosure is to increase coding efficiency and achieve a value limiting filter or the like that is capable of reducing coding distortion.

### Solution to Problem

To solve the above-described problem, a value limiting filter apparatus according to an aspect of the present disclosure includes a first transform processing unit configured to transform an input image signal defined by a certain color space into an image signal of another color space, a limiting unit configured to perform processing of limiting a pixel value on the image signal transformed by the first transform processing unit, and a second transform processing unit configured to transform the image signal having the pixel value limited by the limiting unit into the image signal of the certain color space.

According to the above-described configuration, the input image signal is transformed into the image signal of the other color space different from the original color space by the first transform processing unit. The transformed image signal is transformed into the image signal of the original color space after the limiting unit performs the processing of limiting the pixel value.

### Advantageous Effects of Disclosure

According to the value limiting filter apparatus according to one aspect of the present disclosure, coding efficiency can be increased and a value limiting filter or the like capable of reducing coding distortion can be realized.

### BRIEF DESCRIPTION OF DRAWINGS

FIG. 1 is a diagram illustrating a hierarchical structure of data of a coding stream according to the present embodiment.

FIG. 2 is a diagram illustrating patterns of PU split modes. (a) to (h) illustrate partition shapes in cases that PU split modes are 2N×2N, 2N×N, 2N×nU, 2N×nD, N×2N, nL×2N, nR×2N, and N×N, respectively.

FIG. 3 is a block diagram illustrating a configuration of a loop filter according to the present embodiment.

FIG. 4 is a block diagram illustrating a configuration of an image coding apparatus according to the present embodiment.

FIG. 5 is a schematic diagram illustrating a configuration of an image decoding apparatus according to the present embodiment.

FIG. 6 is a schematic diagram illustrating a configuration of an inter prediction image generation unit of the image coding apparatus according to the present embodiment.

FIG. 7 is a block diagram illustrating a configuration of a loop filter configuration unit.

FIG. 8 is a block diagram illustrating a configuration of a range information generation unit.

FIG. 9 is a block diagram illustrating a configuration of an On/Off flag information generation unit.

FIG. 10 illustrates graphs illustrating pixel values used in the 8-bit defined in ITU-R BT.709, of which (a) is a graph illustrating the relationship between Cr and Y, (b) is a graph illustrating the relationship between Cb and Y, and (c) is a graph illustrating the relationship between Cb and Cr.

FIG. 11 illustrates data structures, of which (a) is a data structure of syntax of the SPS level information, (b) thereof is a data structure of syntax of the slice header level information, and (c) thereof is a data structure of syntax of the loop filter information or the range information of the coding parameters.

FIG. 12 illustrates examples of data structure, of which (a) is a diagram illustrating an example of a data structure of syntax of a CTU, and (b) thereof is a diagram illustrating an example of a data structure of syntax of On/Off flag information of a CTU level.

FIG. 13 is a diagram illustrating a configuration of a value limiting filter processing unit of a luminance signal.

FIG. 14 is a diagram illustrating a configuration of a value limiting filter processing unit of a chrominance signal.

FIG. 15 is a diagram illustrating a configuration of a value limiting filter processing unit of luminance and chrominance signals.

FIG. 16 is a diagram illustrating configurations of a transmitting apparatus equipped with the image coding apparatus and a receiving apparatus equipped with the image decoding apparatus according to the present embodiment. (a) thereof illustrates the transmitting apparatus equipped with the image coding apparatus, and (b) thereof illustrates the receiving apparatus equipped with the image decoding apparatus.

FIG. 17 is a diagram illustrating configurations of a recording apparatus equipped with the image coding apparatus and a reconstruction apparatus equipped with the image decoding apparatus according to the present embodiment. (a) thereof illustrates the recording apparatus equipped with the image coding apparatus, and (b) thereof illustrates the reconstruction apparatus equipped with the image decoding apparatus.

FIG. 18 is a schematic diagram illustrating a configuration of an image transmission system according to the present embodiment.

FIG. 19 is a block diagram illustrating a configuration of a loop filter according to another embodiment of the present disclosure.

FIG. 20 is a flowchart illustrating a flow of processing of the loop filter.

FIG. 21 illustrates data structures, of which (a) is a data structure of syntax of SPS level information, and (b) thereof is a data structure of syntax of explicit color space information.

FIG. 22 illustrates data structures, of which (a) is a data structure of syntax of slice header level information, and (b) thereof is a data structure of syntax illustrating a case that only the chrominance signal is clipped in images other than monochrome images.

FIG. 23 is a block diagram illustrating a configuration of an image decoding apparatus according to the present embodiment.

FIG. 24 is a block diagram illustrating a configuration of an image coding apparatus according to the present embodiment.

FIG. 25 is a block diagram illustrating a configuration of an image decoding apparatus according to a modification of the present embodiment.

FIG. 26 is a block diagram illustrating a specific configuration of a color space boundary region quantization parameter information generation unit 313 according to the present embodiment.

FIG. 27 illustrates graphs, of which (a) is a graph illustrating a color space of a luminance Y and a chrominance Cb. (b) thereof is a graph illustrating the color space of the luminance Y and a chrominance Cr. (c) thereof is a graph illustrating the color space of the chrominance Cb and the chrominance Cr.

FIG. 28 is a flowchart diagram illustrating an explicit determination method for a boundary region by the image decoding apparatus according to the present embodiment.

FIG. 29 is a flowchart diagram illustrating an implicit determination method for a boundary region by the color space boundary region quantization parameter information generation unit according to the present embodiment.

FIG. 30 is a block diagram illustrating a specific configuration of a color space boundary determination unit according to a first specific example of the present embodiment.

FIG. 31 is a flowchart diagram illustrating an implicit determination method for a boundary region by the color space boundary determination unit according to the first specific example of the present embodiment.

FIG. 32 is a block diagram illustrating a specific configuration of a color space boundary determination unit according to a second specific example of the present embodiment.

FIG. 33 is a flowchart diagram illustrating an implicit determination method for a boundary region by the color space boundary determination unit according to the second specific example of the present embodiment.

FIG. 34 illustrates a table in which quantization parameters for pixel values included in a region other than a boundary region are associated with quantization parameters for pixel values included in the boundary region in a color space, to be referred to by a quantization parameter generation processing unit according to the present embodiment.

FIG. 35 illustrates syntax tables, of which (a) to (d) are syntax tables respectively indicating syntax used in a boundary region determination method and a quantization parameter configuration method by a color space boundary region quantization parameter information generation unit according to the present embodiment.

### DESCRIPTION OF EMBODIMENTS

### First Embodiment

Hereinafter, embodiments of the present disclosure will be described with reference to the drawings.

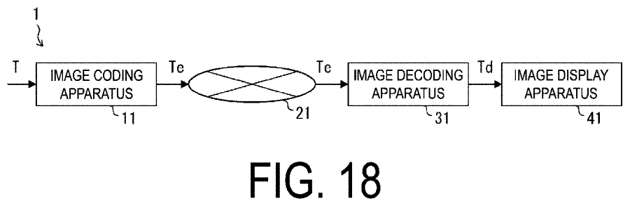

FIG. 18 is a block diagram illustrating a configuration of an image transmission system 1 according to the present embodiment.

The image transmission system 1 is a system in which codes of a coding target image are transmitted, the transmitted codes are decoded, and thus an image is displayed. The image transmission system 1 includes an image coding apparatus (video coding apparatus) 11, a network 21, an image decoding apparatus (video decoding apparatus) 31, and an image display apparatus 41.

An image T indicating an image of a single layer or multiple layers is input to the image coding apparatus 11. A layer is a concept used to distinguish multiple pictures in a case that there are one or more pictures constituting a certain time. For example, coding identical pictures in multiple layers having different image qualities and resolutions is scalable coding, and coding pictures having different viewpoints in multiple layers is view scalable coding. In a case that a prediction (an inter-layer prediction, an inter-view prediction) between pictures in multiple layers is performed, coding efficiency greatly improves. In addition, in a case that a prediction is not performed (simulcast), coded data can be compiled.

The network 21 transmits a coding stream Te generated by the image coding apparatus 11 to the image decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting of the like. The network 21 may be substituted by a storage medium in which the coding stream Te is recorded, such as a Digital Versatile Disc (DVD) or a Blue-ray Disc (BD).

The image decoding apparatus 31 decodes each of the coding streams Te transmitted from the network 21 and generates one or each of multiple decoded images Td.

The image display apparatus 41 displays all or part of the one or multiple decoded images Td generated by the image decoding apparatus 31. For example, the image display apparatus 41 includes a display device such as a liquid crystal display and an organic Electro-Luminescence (EL) display. In addition, in spatial scalable coding and SNR scalable coding, in a case that the image decoding apparatus 31 and the image display apparatus 41 have a high processing capability, an enhanced layer image having high image quality is displayed, and in a case that the apparatuses have a lower processing capability, a base layer image which does not require as high a processing capability and display capability as an enhanced layer is displayed.

### Operator

Operators used in the present specification will be described below.

>> is a right bit shift, << is a left bit shift, & is a bitwise AND, | is a bitwise OR, and |= is an OR assignment operator.

x?y:z is a ternary operator to take y in a case that x is true (other than 0) and take z in a case that x is false (0).

Clip3 (a, b, c) is a function to clip c in a value equal to or greater than a and less than or equal to b, and a function to return a in a case that c is less than a (c<a), return b in a case that c is greater than b (c>b), and return c in other cases (provided that a is less than or equal to b (a<=b)).

### Structure of Coding Stream Te

Prior to the detailed description of the image coding apparatus 11 and the image decoding apparatus 31 according to the present embodiment, a data structure of the coding stream Te generated by the image coding apparatus 11 and decoded by the image decoding apparatus 31 will be described.

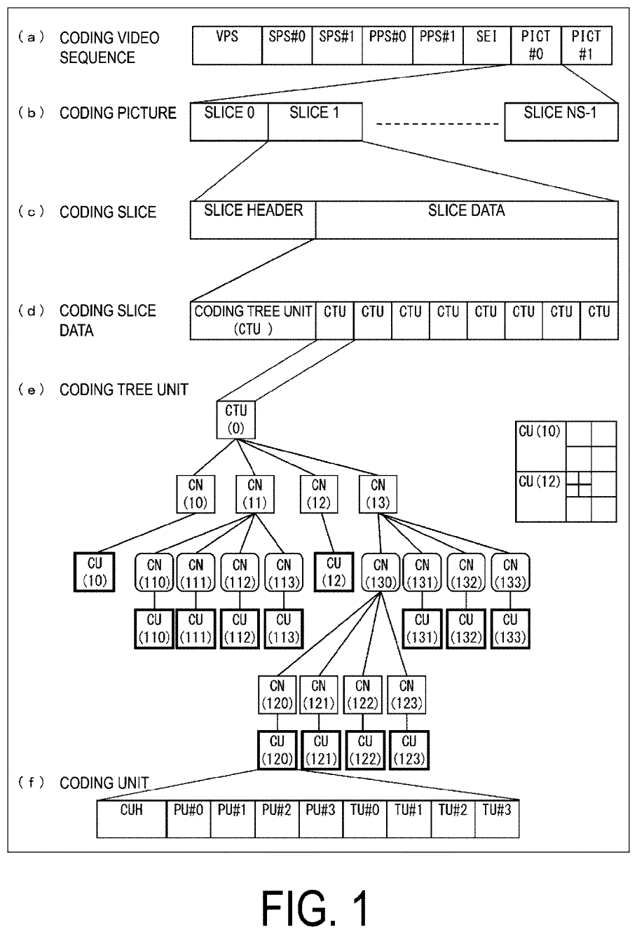

FIG. 1 is a diagram illustrating a hierarchical structure of data of the coding stream Te. The coding stream Te includes a sequence and multiple pictures constituting the sequence illustratively. (a) to (f) of FIG. 1 are diagrams illustrating a coding video sequence defining a sequence SEQ, a coding picture defining a picture PICT, a coding slice defining a slice S, a coding slice data defining slice data, a coding tree unit included in the coding slice data, and a coding unit (CU) included in each coding tree unit, respectively.

### Coding Video Sequence

In the coding video sequence, a set of data referred to by the image decoding apparatus 31 to decode the sequence SEQ to be processed is defined. As illustrated in (a) of FIG. 1, the sequence SEQ includes a Video Parameter Set, a Sequence Parameter Set SPS, a Picture Parameter Set PPS, a picture PICT, and Supplemental Enhancement Information SEI. Here, a value indicated after # indicates a layer ID. Although an example in which there is coded data of #0 and #1, that is, layer 0 and layer 1, is illustrated in FIG. 1, types of layers and the number of layers are not limited thereto.

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the image decoding apparatus 31 to decode a target sequence is defined. For example, a width and a height of a picture are defined. Note that multiple SPSs may exist. In that case, any of multiple SPSs is selected from the PPS.

In the picture parameter set PPS, a set of coding parameters referred to by the image decoding apparatus 31 to decode each picture in a target sequence is defined. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coding Picture

In the coding picture, a set of data referred to by the image decoding apparatus 31 to decode the picture PICT to be processed is defined. As illustrated in (b) of FIG. 1, the picture PICT includes slices 50 to SNS-1 (NS is the total number of slices included in the picture PICT).

Note that in a case that it is not necessary to distinguish each of the slices S0 to SNS−1 below, subscripts of reference signs may be omitted. In addition, the same applies to other data with subscripts included in the coding stream Te which will be described below.

### Coding Slice

In the coding slice, a set of data referred to by the image decoding apparatus 31 to decode the slice S to be processed is defined. As illustrated in (c) of FIG. 1, the slice S includes a slice header SH and a slice data SDATA.

The slice header SH includes a coding parameter group referred to by the image decoding apparatus 31 to determine a decoding method for a target slice. Slice type specification information (slice_type) indicating a slice type is one example of a coding parameter included in the slice header SH.

Examples of slice types that can be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like.

Note that, the slice header SH may include a reference to the picture parameter set PPS (pic_parameter_set_id) included in the coding video sequence.

### Coding Slice Data

In the coding slice data, a set of data referred to by the image decoding apparatus 31 to decode the slice data SDATA to be processed is defined. As illustrated in (d) of FIG. 1, the slice data SDATA includes Coding Tree Units (CTUs). A CTU is a block of a fixed size (for example, 64×64) constituting a slice, and may be called a Largest Coding Unit (LCU).

### Coding Tree Unit

As illustrated in (e) of FIG. 1, a set of data referred to by the image decoding apparatus 31 to decode a coding tree unit to be processed is defined. The coding tree unit is split by recursive quad tree splits. Nodes of a tree structure obtained by recursive quad tree splits are referred to as Coding Nodes (CNs). Intermediate nodes of a quad tree are coding nodes, and the coding tree unit itself is also defined as a highest coding node. The CTU includes a split flag (cu_split_flag), and in a case that cu_split_flag is 1, the CTU is split into four coding node CNs. In a case that cu_split_flag is 0, the coding node CN is not split, and has one Coding Unit (CU) as a node. The coding unit CU is an end node of the coding nodes and is not split any further. The coding unit CU is a basic unit of coding processing.

In addition, in a case that a size of the coding tree unit CTU is 64×64 pixels, a size of the coding unit may be any of 64×64 pixels, 32×32 pixels, 16×16 pixels, and 8×8 pixels.

### Coding Unit

As illustrated in (f) of FIG. 1, a set of data referred to by the image decoding apparatus 31 to decode the coding unit to be processed is defined. Specifically, the coding unit includes a prediction tree, a transform tree, and a CU header CUH. In the CU header, a prediction mode, a split method (PU split mode), and the like are defined.

In the prediction tree, prediction information (a reference picture index, a motion vector, and the like) of each prediction unit (PU) obtained by splitting the coding unit into one or more is defined. In another expression, the prediction unit is one or multiple non-overlapping regions constituting the coding unit. In addition, the prediction tree includes one or multiple prediction units obtained by the above-mentioned split. Note that, in the following, a unit of prediction in which the prediction unit is further split is referred to as a “subblock.” The subblock includes multiple pixels. In a case that sizes of a prediction unit and a subblock are the same, there is one subblock in the prediction unit. In a case that the prediction unit has a larger size than the subblock, the prediction unit is split into subblocks. For example, in a case that the prediction unit has a size of 8×8, and the subblock has a size of 4×4, the prediction unit is split into four subblocks which include two horizontal splits and two vertical splits.

Prediction processing may be performed for each of such prediction units (subblocks).

Generally speaking, there are two types of splits in the prediction tree, including a case of an intra prediction and a case of an inter prediction. The intra prediction refers to a prediction in an identical picture, and the inter prediction refers to prediction processing performed between different pictures (for example, between pictures of different display times, and between pictures of different layer images).

In a case of the intra prediction, a split method has sizes of 2N×2N (the same size as that of the coding unit) and N×N.

In addition, in a case of the inter prediction, the split method includes coding in a PU split mode (part_mode) of coded data, and has sizes of 2N×2N (the same size as that of the coding unit), 2N×N, 2N×nU, 2N×nD, N×2N, nL×2N, nR×2N and N×N, and the like. Note that 2N×N and N×2N indicate a symmetric split of 1:1, and 2N×nU, 2N×nD and nL×2N, nR×2N indicate an asymmetric split of 1:3 and 3:1. The PUs included in the CU are expressed as PU0, PU1, PU2, and PU3 sequentially.

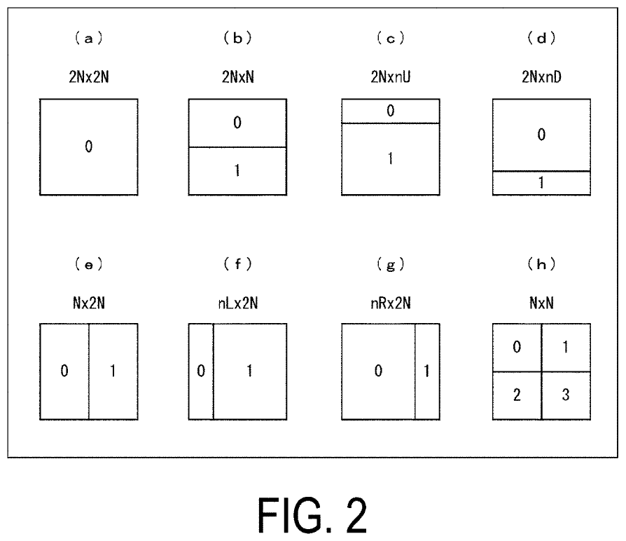

(a) to (h) of FIG. 2 illustrate shapes of partitions in respective PU split modes (positions of boundaries of PU splits) specifically. (a) of FIG. 2A illustrates a partition of 2N×2N, and (b), (c), and (d) of FIG. 2 illustrate partitions (horizontally long partitions) of 2N×N, 2N×nU, and 2N×nD, respectively. (e), (f), and (g) of FIG. 2 illustrate partitions (vertically long partitions) in cases of N×2N, nL×2N, and nR×2N, respectively, and (h) illustrates a partition of N×N. Note that horizontally long partitions and vertically long partitions are collectively referred to as rectangular partitions, and 2N×2N and N×N are collectively referred to as square partitions.

In addition, in the transform tree, the coding unit is split into one or multiple transform units, and a position and a size of each transform unit are defined. In another expression, the transform unit is one or multiple non-overlapping regions constituting the coding unit. In addition, the transform tree includes one or multiple transform units obtained by the above-mentioned split.

Splits in the transform tree include those to allocate a region in the same size as that of the coding unit as a transform unit, and those by recursive quad tree splits similarly to the above-mentioned split of CUs.

Transform processing is performed for each of these transform units.

### Configuration of Image Decoding Apparatus

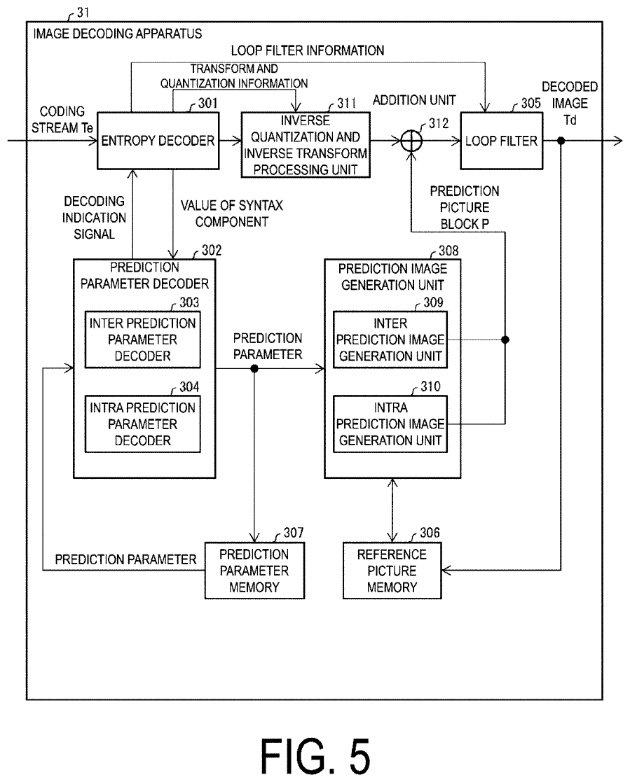

Next, a configuration of the image decoding apparatus 31 according to the present embodiment will be described. FIG. 5 is a schematic diagram illustrating a configuration of the image decoding apparatus 31 according to the present embodiment. The image decoding apparatus 31 includes an entropy decoder 301, a prediction parameter decoder (a prediction image decoding apparatus) 302, a loop filter 305 (including a value limiting filter 3050 (a value limiting filter apparatus)), a reference picture memory 306, a prediction parameter memory 307, a prediction image generation unit (a prediction image generation apparatus) 308, an inverse quantization and inverse transform processing unit 311, and an addition unit 312.

In addition, the prediction parameter decoder 302 includes an inter prediction parameter decoder 303 and an intra prediction parameter decoder 304. The prediction image generation unit 308 includes an inter prediction image generation unit 309 and an intra prediction image generation unit 310.

The entropy decoder 301 performs entropy decoding on the coding stream Te input from the outside and separates and decodes individual codes (syntax components). The separated codes include prediction information to generate a prediction image and residual information to generate a difference image and the like.

The entropy decoder 301 outputs a part of the separated codes to the prediction parameter decoder 302. For example, a part of the separated codes includes a prediction mode predMode, a PU split mode part_mode, a merge flag merge_flag, a merge index merge_idx, an inter prediction indicator inter_pred_idc, a reference picture index refIdxLX, a prediction vector index mvp_LX_idx, and a difference vector mvdLX. Which code is to be decoded is controlled based on an indication of the prediction parameter decoder 302. The entropy decoder 301 outputs quantization coefficients to the inverse quantization and inverse transform processing unit 311. These quantization coefficients are coefficients obtained by performing a frequency transform such as a Discrete Cosine Transform (DCT), a Discrete Sine Transform (DST), or a Karyhnen Loeve Transform (KLT) on residual signals to quantize the signals in coding processing.

In addition, the entropy decoder 301 transmits range information and On/Off flag information included in the coding stream Te to the loop filter 305. In the present embodiment, the range information and the On/Off flag information are included as part of the loop filter information.

The range information and the On/Off flag information may be defined, for example, on a per slice basis, or may be defined on a per picture basis. In addition, units in which the range information and the On/Off flag information are defined may be the same, and a unit of the range information may be larger than that of the On/Off flag information. For example, the range information may be defined on a per picture basis and the On/Off flag information may be defined on a per slice basis.

The inter prediction parameter decoder 303 decodes an inter prediction parameter with reference to a prediction parameter stored in the prediction parameter memory 307, based on a code input from the entropy decoder 301.

The inter prediction parameter decoder 303 outputs a decoded inter prediction parameter to the prediction image generation unit 308, and also stores the decoded inter prediction parameter in the prediction parameter memory 307. Details of the inter prediction parameter decoder 303 will be described below.

The intra prediction parameter decoder 304 decodes an intra prediction parameter with reference to a prediction parameter stored in the prediction parameter memory 307, based on a code input from the entropy decoder 301. The intra prediction parameter is a parameter used in processing to predict a CU in one picture, for example, an intra prediction mode IntraPredMode. The intra prediction parameter decoder 304 outputs a decoded intra prediction parameter to the prediction image generation unit 308, and also stores the decoded intra prediction parameter in the prediction parameter memory 307.

The intra prediction parameter decoder 304 may derive different intra prediction modes depending on luminance and chrominance. In this case, the intra prediction parameter decoder 304 decodes a luminance prediction mode IntraPredModeY as a prediction parameter of luminance and decodes a chrominance prediction mode IntraPredModeC as a prediction parameter of chrominance. The luminance prediction mode IntraPredModeY includes 35 modes, and corresponds to a planar prediction (0), a DC prediction (1), and directional predictions (2 to 34). The chrominance prediction mode IntraPredModeC uses any of the planar prediction (0), the DC prediction (1), the directional predictions (2 to 34), and an LM mode (35). The intra prediction parameter decoder 304 may decode a flag indicating whether IntraPredModeC is the same mode as the luminance mode, assign IntraPredModeY to IntraPredModeC in a case of that the flag indicates the same mode as the luminance mode, and decode the planar prediction (0), the DC prediction (1), the directional predictions (2 to 34), and the LM mode (35) as IntraPredModeC in a case of that the flag indicates a different mode from the luminance mode.

The loop filter 305 applies a filter such as a deblocking filter, a Sample Adaptive Offset (SAO), and an Adaptive Loop Filter (ALF) on a decoded image of a CU generated by the addition unit 312. In addition, the value limiting filter 3050 in the loop filter 305 performs processing for limiting pixel values on the decoded image after the filter is applied. Details of the value limiting filter 3050 will be described below.

The reference picture memory 306 stores a decoded image of the CU generated by the addition unit 312 in a predetermined position for each picture and CU to be decoded.

The prediction parameter memory 307 stores a prediction parameter in a predetermined position for each picture and prediction unit (or a subblock, a fixed size block, and a pixel) to be decoded. Specifically, the prediction parameter memory 307 stores an inter prediction parameter decoded by the inter prediction parameter decoder 303, an intra prediction parameter decoded by the intra prediction parameter decoder 304 and a prediction mode predMode separated by the entropy decoder 301. For example, stored inter prediction parameters include a prediction list use flag predFlagLX (inter prediction indicator inter_pred_idc), a reference picture index refIdxLX, and a motion vector mvLX.

The prediction image generation unit 308 receives input of a prediction mode predMode from the entropy decoder 301 and a prediction parameter from the prediction parameter decoder 302. In addition, the prediction image generation unit 308 reads a reference picture from the reference picture memory 306. The prediction image generation unit 308 generates a prediction image of a PU or a subblock by using the input prediction parameter and the read reference picture (reference picture block) in the prediction mode indicated by the prediction mode predMode.

Here, in a case that the prediction mode predMode indicates an inter prediction mode, the inter prediction image generation unit 309 generates a prediction image of a PU or a subblock using an inter prediction by using the inter prediction parameter input from the inter prediction parameter decoder 303 and the read reference picture (reference picture block).

For a reference picture list (an L0 list or an L1 list) in which the prediction list use flag predFlagLX is 1, the inter prediction image generation unit 309 reads, from the reference picture memory 306, a reference picture block at a position indicated by a motion vector mvLX with reference to the PU to be decoded in the reference picture indicated by the reference picture index refIdxLX. The inter prediction image generation unit 309 performs a prediction based on a read reference picture block and generates a prediction image of the PU. The inter prediction image generation unit 309 outputs the generated prediction image of the PU to the addition unit 312. Here, the reference picture block refers to a set of pixels (referred to as a block because they are normally rectangular) on a reference picture and is a region that is referred to generate a prediction image of a PU or a subblock.

In a case that the prediction mode predMode indicates an intra prediction mode, the intra prediction image generation unit 310 performs an intra prediction by using an intra prediction parameter input from the intra prediction parameter decoder 304 and a read reference picture. Specifically, the intra prediction image generation unit 310 reads, from the reference picture memory 306, a PU, which is a picture to be decoded, and a PU neighboring a PU to be decoded in a predetermined range among PUs that have already been decoded. The predetermined range is, for example, any of neighboring PUs on left, top left, top, and top right sides in a case that a PU to be decoded sequentially moves in an order of a so-called raster scan and varies according to intra prediction modes. The order of the raster scan is an order of sequential movement from the left edge to the right edge in each picture for each row from the top edge to the bottom edge.

The intra prediction image generation unit 310 performs a prediction in a prediction mode indicated by the intra prediction mode IntraPredMode based on a read neighboring PU and generates a prediction image of a PU. The intra prediction image generation unit 310 outputs the generated prediction image of the PU to the addition unit 312.

In a case that the intra prediction parameter decoder 304 derives different intra prediction modes depending on luminance and chrominance, the intra prediction image generation unit 310 generates a prediction image of a PU of luminance by any of a planar prediction (0), a DC prediction (1), and directional predictions (2 to 34) in accordance with a luminance prediction mode IntraPredModeY, and generates a prediction image of a PU of chrominance by any of a planar prediction (0), a DC prediction (1), directional predictions (2 to 34), and an LM mode (35) in accordance with a chrominance prediction mode IntraPredModeC.

The inverse quantization and inverse transform processing unit 311 performs inverse quantization on a quantization coefficient input from the entropy decoder 301 to calculate a transform coefficient. The inverse quantization and inverse transform processing unit 311 performs an inverse frequency transform such as an inverse DCT, an inverse DST, or an inverse KLT on the calculated transform coefficient to calculate a residual signal. The inverse quantization and inverse transform processing unit 311 outputs the calculated residual signal to the addition unit 312.

The addition unit 312 adds the prediction image of the PU input from the inter prediction image generation unit 309 or the intra prediction image generation unit 310 to the residual signal input from the inverse quantization and inverse transform processing unit 311 for each pixel and generates a decoded image of the PU.

The loop filter 305 performs loop filtering such as deblocking filtering, image reconstruction filtering, and value limiting filtering on the decoded image of the PU generated by the addition unit 312. In addition, the loop filter 305 stores the result of the above processing in the reference picture memory 306 and outputs a decoded image Td obtained by integrating the generated decoded image of the PU for each picture to the outside.

Next, details of the value limiting filter 3050 that is a part of the loop filter 305 will be described below.

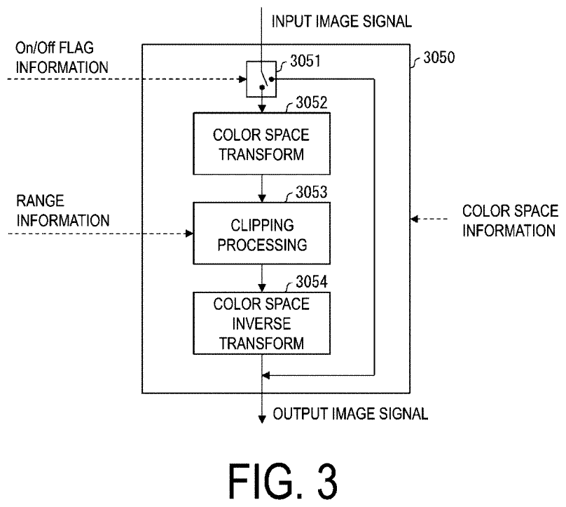

FIG. 3 is a block diagram illustrating a configuration of the value limiting filter 3050. As illustrated in FIG. 3, the value limiting filter 3050 includes a switch unit 3051, a color space transform processing unit 3052 (first transform processing unit), a clipping processing unit 3053 (limiting unit), and a color space inverse transform processing unit 3054 (second transform processing unit).

The switch unit 3051 switches whether to perform processing by the color space transform processing unit 3052, the clipping processing unit 3053, and the color space inverse transform processing unit 3054. In the following description, processing by the color space transform processing unit 3052, the clipping processing unit 3053, and the color space inverse transform processing unit 3054 may be referred to as value limiting filtering. The switch unit 3051 performs the above switching based on an On/Off flag transmitted from the entropy decoder 301. For example, in a case that the On/Off flag is 1, the value limiting filter 3050 performs value limiting filtering. On the other hand, in a case that the On/Off flag is 0, the value limiting filter 3050 does not perform value limiting filtering.

The color space transform processing unit 3052 transforms an input image signal defined by a certain color space into an image signal of another color space (first transform). The transform of the image signal is performed based on color space information described in a slice header level of the input image signal. In a case that the input image signal conforms to ITU-R BT.709, for example, the color space transform processing unit 3052 transforms the input image signal in a YCbCr space into an image signal in an RGB space.

Transform formulas used by the color space transform processing unit 3052 in the present embodiment are as follows.

R=1.164*(Y−16*(BitDepth_{Y}−8))+1.540*(Cr−(1<<(BitDepth_{C}−1)))

G=1.164*(Y−16*(BitDepth_{Y}−8))−0.183*(Cb−(1<<(BitDepth_{C}−1)))−0.459*(Cr−(1<<(BitDepth_{C}−1)))

B=1.164*(Y−16*(BitDepth_{Y}−8)+1.816*(Cb−(1<<(BitDepth_{C}−1)))

In addition, the color space transform processing unit 3052 may use transform formulas for a YCgCo transform capable of an integer transform. In this case, specific transform formulas used by the color space transform processing unit 3052 are as follows.

t=Y−(Cb−(1<<(BitDepth_{C}−1)))

G=Y+(Cb−(1<<(BitDepth_{C}−1)))

B=t−(Cr−(1<<(BitDepth_{C}−1)))

R=t+(Cr−(1<<(BitDepth_{C}−1)))

Note that the input image signal is the sum of (i) a prediction image P generated by the prediction image generation unit 308 and (ii) a residual signal calculated by the inverse quantization and inverse transform processing unit 311. Thus, the input image signal is not a signal (source image signal) of an image T input to the image coding apparatus 11.

The clipping processing unit 3053 performs processing for limiting the pixel value of the image signal transformed by the color space transform processing unit 3052. Specifically, the clipping processing unit 3053 modifies the pixel value of the image signal to a pixel value within a range defined by the range information transmitted from the entropy decoder 301.

Specifically, the clipping processing unit 3053 performs the following processing on a pixel value z based on the minimum value min_value and the maximum value max_value included in the range information.

$$Clip 3 ( min\_value , max\_value , z ) = \{ \begin{matrix}min\_value ; & z < min\_value \\ max\_value ; & z > max\_value \\ z ; & otherwise\end{matrix} \qquad Expression 1$$

In other words, in a case that the pixel value z is less than the minimum value min_value, the clipping processing unit 3053 modifies the pixel value z to a value equal to the minimum value min_value. In addition, in a case that the pixel value z is greater than the maximum value max_value, the clipping processing unit 3053 modifies the pixel value z to a value equal to the maximum value max_value. In a case that the pixel value z is equal to or greater than the minimum value min_value and less than or equal to the maximum value max_value, the clipping processing unit 3053 does not modify the pixel value z.

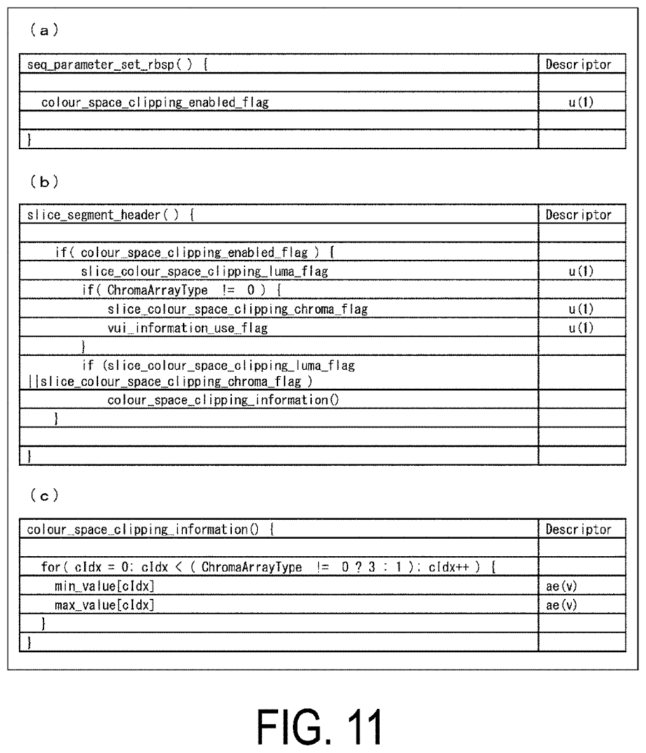

The clipping processing unit 3053 performs the above-described processing on each of the color components (e.g., R, G, and B) in the color space. In other words, each of R, G, and B is processed being regarded as the pixel value z. In addition, the range information min_value and max_value of the respective color components differ for each color component. For example, (c) of FIG. 11 illustrates an example of transmission for each color component indicated by a color space index cIdx.

The color space inverse transform processing unit 3054 inversely transforms the image signal having the pixel value limited by the clipping processing unit 3053 into an image signal of the original color space (second transform). The inverse transform is performed based on the color space information, similarly to the transform by the color space transform processing unit 3052. For example, in a case that the input image signal conforms to ITU-R BT. 709, the color space inverse transform processing unit 3054 transforms the image signal of the RGB space into an image signal of a YCbCr space.

Specific color space inverse transform formulas for the color space inverse transform processing unit 3054 are as follows.

t=0.2126*R+0.7152*G+0.0722*B

Y=t*219.0/255.0+16*(BitDepth_{Y}−8)

Cb=0.5389*(B−Y)*224.0/255.0+(1<<(BitDepth_{C}−1))

Cr=0.6350*(R−Y)*224.0/255.0+(1<<(BitDepth_{C}−1))

In addition, in a case that the color space transform processing unit 3052 uses transform formulas for the YCgCo transform capable of an integer transform, the specific color space inverse transform formulas used by the color space inverse transform processing unit 3054 are as follows.

Y=0.5*G+0.25*(R+B)

Cb=0.5*G−0.25*(R+B)+(1<<(BitDepth_{C}−1))

Cr=0.5*(R−B)+(1<<(BitDepth_{C}−1))

Note that the value limiting filter 3050 need not necessarily include a switch unit 3051. In a case that the value limiting filter 3050 does not include the switch unit 3051, the value limiting filtering should always be executed on the input image signal.

However, by including the switch unit 3051, the value limiting filter 3050 can switch whether to perform the value limiting filtering as necessary. In particular, as described above, it is preferable that the switch unit 3051 switches whether to perform the value limiting filtering based on the On/Off flag information as necessary, because an error in the image signal output from the value limiting filter 3050 can be reduced.

Although an example in which the value limiting filter 3050 is applied to the loop filter 305 in the image decoding apparatus 31 of the present embodiment has been indicated, it may be applied to the inter prediction image generation unit 309 and the intra prediction image generation unit 310 of the prediction image generation unit 308. In this case, the input image signal input to the value limiting filter 3050 is an inter prediction image signal or intra prediction image signal. Furthermore, the range information and the On/Off flag information are included in part of the coding parameters.

### Configuration of Image Coding Apparatus

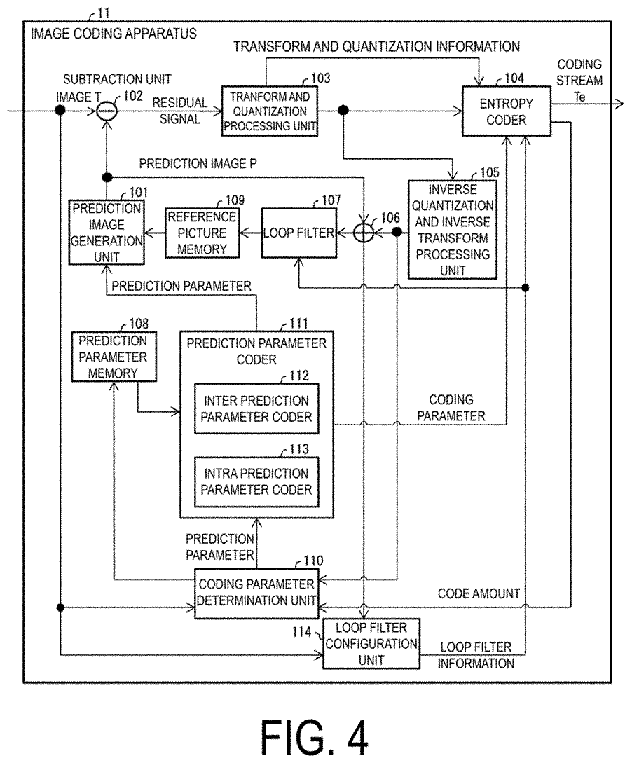

Next, a configuration of the image coding apparatus 11 according to the present embodiment will be described. FIG. 4 is a block diagram illustrating a configuration of the image coding apparatus 11 according to the present embodiment. The image coding apparatus 11 is configured to include a prediction image generation unit 101, a subtraction unit 102, a transform and quantization processing unit 103, an entropy coder 104, an inverse quantization and inverse transform processing unit 105, an addition unit 106, a loop filter 107 (including a value limiting filter 3050), a prediction parameter memory (a prediction parameter storage unit and a frame memorY) 108, a reference picture memory (a reference image storage unit and a frame memorY) 109, a coding parameter determination unit 110, a prediction parameter coder 111, and a loop filter configuration unit 114. The prediction parameter coder 111 is configured to include an inter prediction parameter coder 112 and an intra prediction parameter coder 113.

For each picture of an image T, the prediction image generation unit 101 generates a prediction image P of a prediction unit PU for each coding unit CU that is a region obtained by splitting the picture. Here, the prediction image generation unit 101 reads a block that has been decoded from the reference picture memory 109 based on a prediction parameter input from the prediction parameter coder 111. For example, in a case of an inter prediction, the prediction parameter input from the prediction parameter coder 111 is a motion vector. The prediction image generation unit 101 reads a block at a position in a reference image indicated by the motion vector starting from a target PU. In addition, in a case of an intra prediction, the prediction parameter is, for example, an intra prediction mode. A pixel value of a neighboring PU used in the intra prediction mode is read from the reference picture memory 109, and the prediction image P of the PU is generated. The prediction image generation unit 101 generates the prediction image P of the PU by using one prediction scheme among multiple prediction schemes for a read reference picture block. The prediction image generation unit 101 outputs the generated prediction image P of the PU to the subtraction unit 102.

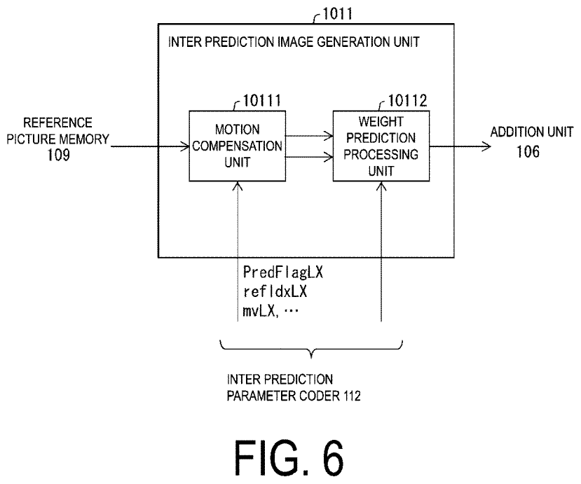

Note that the operation of the prediction image generation unit 101 is the same as that of the prediction image generation unit 308 already described. For example, FIG. 6 is a schematic diagram illustrating a configuration of an inter prediction image generation unit 1011 included in the prediction image generation unit 101. The inter prediction image generation unit 1011 is configured to include a motion compensation unit 10111 and a weight prediction processing unit 10112. Descriptions about the motion compensation unit 10111 and the weight prediction processing unit 10112 are omitted since the motion compensation unit 10111 and the weight prediction processing unit 10112 have similar configurations of the above-mentioned motion compensation unit 3091 and weight prediction processing unit 3094, respectively.

The prediction image generation unit 101 generates a prediction image P of a PU based on a pixel value of a reference block read from the reference picture memory, using a parameter input by the prediction parameter coder. The prediction image generated by the prediction image generation unit 101 is output to the subtraction unit 102 and the addition unit 106.

The subtraction unit 102 subtracts a signal value of the prediction image P of the PU input from the prediction image generation unit 101 from a pixel value of a corresponding PU of the image T to generate a residual signal. The subtraction unit 102 outputs the generated residual signal to the transform and quantization processing unit 103.

The transform and quantization processing unit 103 performs a frequency transform on the residual signal input from the subtraction unit 102 to calculate a transform coefficient. The transform and quantization processing unit 103 quantizes the calculated transform coefficient to obtain a quantization coefficient. The transform and quantization processing unit 103 outputs the obtained quantization coefficient to the entropy coder 104 and the inverse quantization and inverse transform processing unit 105.

To the entropy coder 104, the quantization coefficient is input from the transform and quantization processing unit 103, and coding parameters are input from the prediction parameter coder 111. For example, input coding parameters include codes such as a reference picture index refIdxLX, a prediction vector index mvp_LX_idx, a difference vector mvdLX, a prediction mode predMode, and a merge index merge_idx.

The entropy coder 104 performs entropy coding on the input quantization coefficient and coding parameters and loop filter information (which will be described below) generated by the loop filter configuration unit 114 to generate a coding stream Te and outputs the generated coding stream Te to the outside.

The inverse quantization and inverse transform processing unit 105 performs inverse quantization on the quantization coefficient input from the transform and quantization processing unit 103 to obtain a transform coefficient. The inverse quantization and inverse transform processing unit 105 performs an inverse frequency transform on the obtained transform coefficient to calculate a residual signal. The inverse quantization and inverse transform processing unit 105 outputs the calculated residual signal to the addition unit 106.

The addition unit 106 adds a signal value of the prediction image P of the PU input from the prediction image generation unit 101 to a signal value of the residual signal input from the inverse quantization and inverse transform processing unit 105 for each pixel and generates a decoded image. The addition unit 106 stores the generated decoded image in the reference picture memory 109.

The loop filter 107 applies a deblocking filter, Sample Adaptive Offset (SAO), and an Adaptive Loop Filter (ALF) to the decoded image generated by the addition unit 106. In addition, the loop filter 107 includes the value limiting filter 3050. However, the loop filter 107 receives input of the On/Off flag information and the range information from the loop filter configuration unit 114.

The loop filter configuration unit 114 generates loop filter information to be used in the loop filter 107. Details of the loop filter configuration unit 114 will be described below.

The prediction parameter memory 108 stores the prediction parameters generated by the coding parameter determination unit 110 for each picture and CU to be coded at a predetermined position.

The reference picture memory 109 stores the decoded image generated by the loop filter 107 for each picture and CU to be coded at a predetermined position.

The coding parameter determination unit 110 selects one set among multiple sets of coding parameters. A coding parameter refers to the above-mentioned prediction parameter or a parameter to be coded, the parameter being generated in association with the prediction parameter. The prediction image generation unit 101 generates the prediction image P of the PU by using each of the sets of the coding parameters.

The coding parameter determination unit 110 calculates, for each of the multiple sets, a cost value indicating the magnitude of an amount of information and a coding error. A cost value is, for example, the sum of a code amount and the value obtained by multiplying a coefficient λ by a square error. The code amount is an amount of information of the coding stream Te obtained by performing entropy coding on a quantization error and a coding parameter. The square error is the sum of pixels for square values of residual values of residual signals calculated in the subtraction unit 102. The coefficient λ is a real number greater than a preconfigured zero. The coding parameter determination unit 110 selects a set of coding parameters of which cost value calculated is a minimum value. With this configuration, the entropy coder 104 outputs the selected set of coding parameters as the coding stream Te to the outside and does not output an unselected set of coding parameters. The coding parameter determination unit 110 stores the determined coding parameters in the prediction parameter memory 108.

The prediction parameter coder 111 derives a format for coding from parameters input from the coding parameter determination unit 110 and outputs the format to the entropy coder 104. The derivation of the format for coding is, for example, to derive a difference vector from a motion vector and a prediction vector. The prediction parameter coder 111 derives parameters necessary to generate a prediction image from parameters input from the coding parameter determination unit 110 and outputs the parameters to the prediction image generation unit 101. A parameter necessary to generate a prediction image is, for example, a motion vector of a subblock unit.

The inter prediction parameter coder 112 derives inter prediction parameters such as a difference vector based on the prediction parameters input from the coding parameter determination unit 110. The inter prediction parameter coder 112 includes a partly identical configuration to a configuration in which the inter prediction parameter decoder 303 (see FIG. 5 and the like) derives inter prediction parameters, as a configuration for deriving parameters necessary for generation of a prediction image output to the prediction image generation unit 101. A configuration of the inter prediction parameter coder 112 will be described below.

The intra prediction parameter coder 113 derives a format for coding (for example, MPM_idx, rem_intra_luma_pred_mode, or the like) from the intra prediction mode IntraPredMode input from the coding parameter determination unit 110.

Next, details of the loop filter configuration unit 114 will be described below.

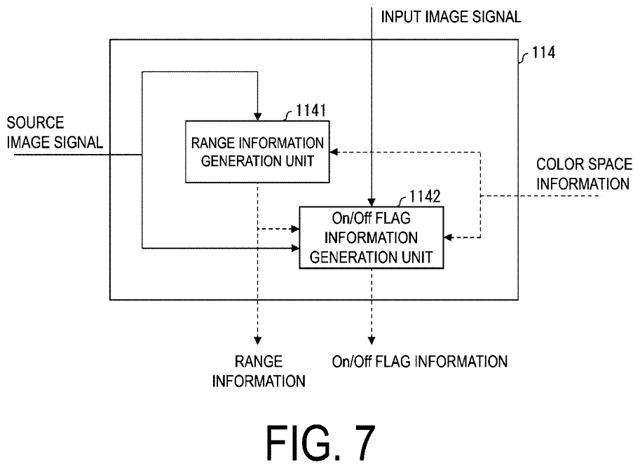

FIG. 7 is a block diagram illustrating a configuration of the loop filter configuration unit 114. As illustrated in FIG. 7, the loop filter configuration unit 114 includes a range information generation unit 1141 and an On/Off flag information generation unit 1142.

Source image signals and color space information are input to each of the range information generation unit 1141 and the On/Off flag information generation unit 1142. The source image signal is a signal of an image T input to the image coding apparatus 11. In addition, an input image signal is input to the On/Off flag information generation unit 1142.

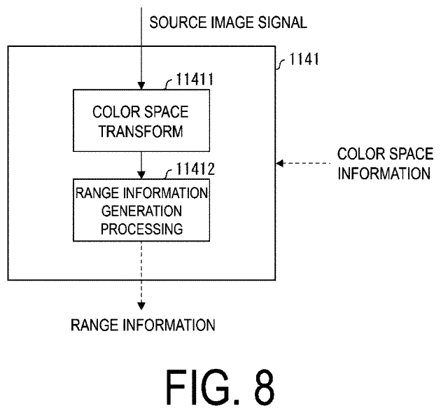

FIG. 8 is a block diagram illustrating a configuration of the range information generation unit 1141. As illustrated in FIG. 8, the range information generation unit 1141 includes a color space transform processing unit 11411 and a range information generation processing unit 11412.

The color space transform processing unit 11411 transforms the source image signal defined by a certain color space into an image signal of another color spaces. Processing in the color space transform processing unit 11411 is similar to the processing in the color space transform processing unit 3052.

The range information generation processing unit 11412 detects a maximum value and a minimum value of a pixel value in the image signal transformed by the color space transform processing unit 11411.

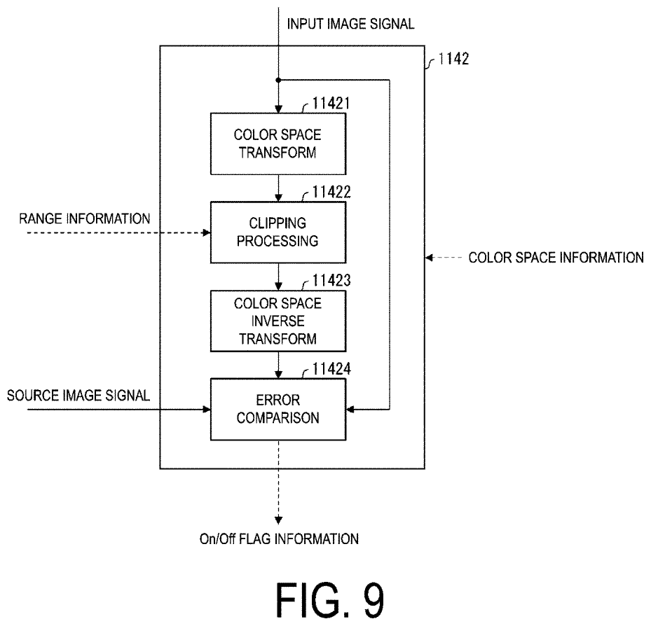

FIG. 9 is a block diagram illustrating a configuration of the On/Off flag information generation unit 1142. As illustrated in FIG. 9, the On/Off flag information generation unit 1142 includes a color space transform processing unit 11421, a clipping processing unit 11422, a color space inverse transform processing unit 11423, and an error comparison unit 11424. Processing in the color space transform processing unit 11421, the clipping processing unit 11422, and the color space inverse transform processing unit 11423 are the same as the processing in the color space transform processing unit 3052, the clipping processing unit 3053, and the color space inverse transform processing unit 3054.

The error comparison unit 11424 compares the following two types of errors.
(i) An error between a source image signal and an input image signal
(ii) An error between a source image signal and an image signal processed in the color space transform processing unit 11421, the clipping processing unit 11422, and the color space inverse transform processing unit 11423

That is, the error comparison unit 11424 compares an error of a case that processing of the color space transform processing unit 11421, the clipping processing unit 11422, and the color space inverse transform processing unit 11423 is performed with an error of a case that the processing is not performed. In other words, the error comparison unit 11424 compares an error of a case that processing of the color space transform processing unit 3052, the clipping processing unit 3053, and the color space inverse transform processing unit 3054 of the value limiting filter 3050 is performed with an error of a case that the processing is not performed.

Furthermore, the error comparison unit 11424 determines a value of the On/Off flag based on the comparison result of the errors. In a case that the error of (i) described above is equal to the error of (ii), or the error of (ii) is larger than the error of (i), the error comparison unit 11424 sets the On/Off flag to 0. On the other hand, in a case that the error of (ii) described above is less than the error of (i) described above, the error comparison unit 11424 sets the On/Off flag to 1.

With the processing described above, the loop filter configuration unit 114 generates loop filter information. The loop filter configuration unit 114 transmits the generated loop filter information to the loop filter 107 and the entropy coder 104.

Note that, some of the image coding apparatus 11 and the image decoding apparatus 31 in the above-described embodiments, for example, the entropy decoder 301, the prediction parameter decoder 302, the loop filter 305, the prediction image generation unit 308, the inverse quantization and inverse transform processing unit 311, the addition unit 312, the prediction image generation unit 101, the subtraction unit 102, the transform and quantization processing unit 103, the entropy coder 104, the inverse quantization and inverse transform processing unit 105, the loop filter 107, the coding parameter determination unit 110, and the prediction parameter coder 111, may be realized by a computer. In that case, this configuration may be realized by recording a program for realizing such control functions on a computer-readable recording medium and causing a computer system to read the program recorded on the recording medium for execution. Note that the “computer system” mentioned here refers to a computer system built into either the image coding apparatus 11 or the image decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically retains a program for a short period of time, such as a communication line in a case that the program is transmitted over a network such as the Internet or over a communication line such as a telephone line, and may also include a medium that retains the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Although an example in which the value limiting filter 3050 is implemented in the loop filter 305 has been indicated in this embodiment, the value limiting filter 3050 may be applied to the prediction image generation unit 101. In this case, the input image signal input to the value limiting filter 3050 is an inter prediction image signal or intra prediction image signal. In addition, the range information and the On/Off flag information are treated as part of the coding parameters.

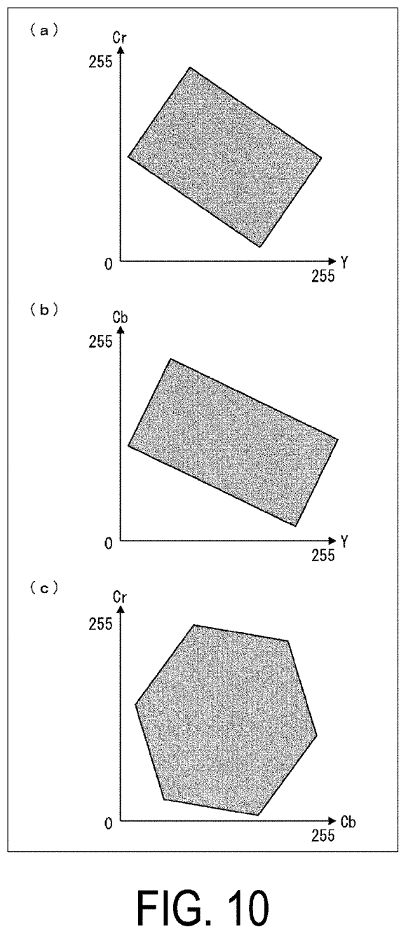

FIG. 10 illustrates graphs each illustrating a pixel value, used in the 8-bit defined in ITU-R BT.709, that is an example of the YCbCr color space. (a) is a graph illustrating the relationship between Cr and Y, (b) is a graph illustrating the relationship between Cb and Y, and (c) is a graph illustrating the relationship between Cb and Cr. In (a) to (c) of FIG. 10, regions of a combination of pixel values used are illustrated with shading.

As illustrated in (a) to (c) of FIG. 10, in the YCbCr color space, the edge of the region of the combination of pixel values used is inclined relative to the axis. Thus, in a case that pixel values are limited based on only the maximum value and the minimum value of the individual pixel values, the combination of pixel values that are not actually used will be included in the limited pixel values.

On the other hand, in an RGB color space, each pixel value takes a value greater than or equal to 0 and less than or equal to 255. Thus, in a case that the region of the combination of pixel values used is plotted on a graph, the edge of the region is parallel or perpendicular to the axis. Thus, in the RGB color space, in a case that the pixel values are limited based on the maximum value and the minimum value of each pixel value, the combination of pixel values that are not actually used will not be included in the limited pixel value.

Note that in the actual image, the minimum value is not 0 and the maximum value is not 255 for each pixel value at all times. The color space transform processing unit 3052 may transform an input image signal into an image signal of an appropriate color space based on the maximum value and the minimum value of the value used in an actual image. In addition, the color space inverse transform processing unit 3054 may perform color space inverse transform of the image signal of the appropriate color space into an image signal of the original color space. In this case, the transforms executed by the color space transform processing unit 3052 and the color space inverse transform processing unit 3054 are preferably linear transforms.

(a) of FIG. 11 is a data structure of syntax of SPS level information. In the present embodiment, colour_space_clipping_enabled_flag included in the SPS level information is a flag for determining whether to perform value limiting filtering in the sequence. In a case that the value limiting filtering in the sequence is prohibited and the switch unit 3051 is turned off at all times, the error comparison unit 11424 sets colour_space_clipping_enabled_flag serving as the On/Off flag described above to 0. On the other hand, in a case that processing of On/Off of the switch unit 3051 is operated at or below a slice, the error comparison unit 11424 sets colour_space_clipping_enabled_flag to 1. An operation performed at or below the slice will be described below with reference to (b) of FIG. 11.

(b) of FIG. 11 is a data structure of syntax of slice header level information. In the present embodiment, color space information is included in the slice header level information. In a case that colour_space_clipping_enabled_flag is 1 in SPS level information, the switch unit 3051 refers to a flag slice_colour_space_clipping_luma_flag indicating whether to allow the luminance value limiting filtering processing at the slice level. In a case that slice_colour_space_clipping_luma_flag is 1, the switch unit 3051 allows the luminance value limiting filtering processing. On the other hand, in a case that slice_colour_space_clipping_luma_flag is 0, the switch unit 3051 prohibits the luminance value limiting filtering processing. Note that default values of slice_colour_space_clipping_luma_flag and slice_colour_space_clipping_chroma_flag are set to 0.

In addition, in a case that ChromaArrayType is not 0, that is, in a case that the image signal is not in a monochrome format, the switch unit 3051 refers to a flag slice_colour_space_clipping_chroma_flag indicating whether to allow the value limiting filtering processing of the chrominance signal. In a case that slice_colour_space_clipping_chroma_flag is 1, the switch unit 3051 allows chrominance value limiting filtering processing. On the other hand, in a case that slice_colour_space_clipping_chroma_flag is 0, the switch unit 3051 prohibits the chrominance value limiting filtering.

Additionally, vui_information_use_flag is a flag indicating whether the color space transform processing unit 3052 and the color space inverse transform processing unit 3054 use color space information of Video Usability Information (VUI). In a case that vui_information_use_flag is 1, the color space transform processing unit 3052 and the color space inverse transform processing unit 3054 use VUI color space information. In a case that vui_information_use_flag is 0, the color space transform processing unit 3052 and the color space inverse transform processing unit 3054 use default color space information. In a case that the default color space information is used, the color space transform processing unit 3052 and the color space inverse transform processing unit 3054 perform, for example, the above-described YCgCo transform and inverse transform, respectively.

Note that, although a method is indicated that uses VUI and default color space information as the color space information in the present embodiment, transform coefficient information of the color space transform and the inverse transform may explicitly be transmitted as the color space transform information on a per sequence basis, a per picture basis, a per slice basis, or the like.

(c) of FIG. 11 is a data structure of syntax of loop filter information or range information of coding parameters. In the range information, a minimum value min_value[cIdx] and a maximum value min_value[cIdx] of a pixel value in a case that the source image signal of the YcbCr color space is transformed into that of the RGB color space are described, the minimum value and the maximum value being detected by the range information generation unit 1141. The values described in the range information may be negative values.

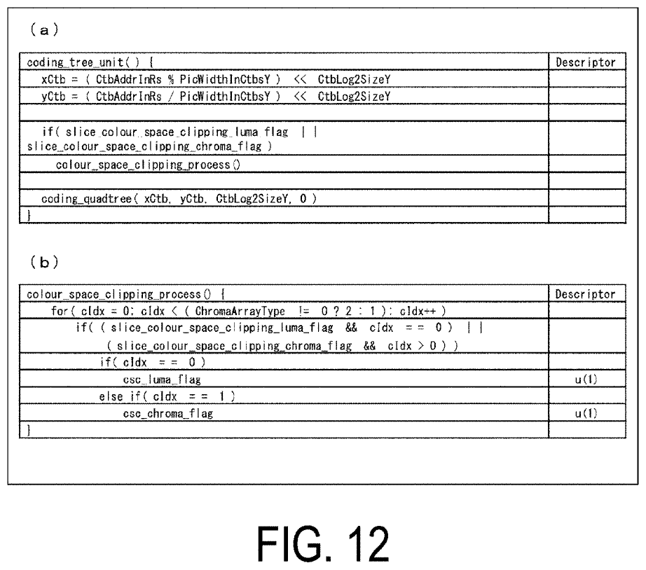

(a) of FIG. 12 is a diagram illustrating an example of a data structure of syntax of a CTU. In the example illustrated in (a) of FIG. 12, in a case that either slice_colour_space_clipping_luma_flag, which is a flag of value limiting filtering in slice units, or slice_colour_space_clipping_chroma_flag is 1, colour_space_clipping_process describing On/Off flag information of value limiting filtering at the CTU level is invoked.

(b) of FIG. 12 is a diagram illustrating an example of a data structure of syntax of colour_space_clipping_process describing On/Off flag information of value limiting filtering at the CTU level. In colour_space_clipping_process, there are a flag csc_luma_flag for allowing whether to perform the value limiting filtering processing of a luminance signal Y and a flag csc_chroma_flag for allowing whether to perform the value limiting filtering processing of the chrominance signals Cb and Cr. In a case that both flags are 1, the value limiting filtering processing is allowed, and in a case that both flags are 0, the value limiting filtering processing is prohibited. In this case, the loop filters 305 and 107 perform the processing on a CTU basis.

The number of pixels of the luminance signal Y and the number of pixels of the chrominance signals Cb and Cr differ in the formats of 4:2:0 and 4:2:2, which are image formats commonly used in video coding apparatuses and video decoding apparatuses. Therefore, it is necessary to cause the number of pixels of the luminance to match the number of pixels of the chrominance for the color space transform and the color space inverse transform. For this reason, processing for the luminance signal and processing for the chrominance signal are performed separately. Such value limiting filtering processing will be described again in Embodiment 2.

### Effect

In a case that the coded image is decoded, the coding distortion may cause the decoded image to have a pixel value in a range of pixel values that are not present in the source image signal. According to the loop filter 305 of the present embodiment, in a case that the decoded image has a pixel value in the range of pixel values that are not present in the source image signal, the image quality of the decoded image can be improved by modifying the pixel value to a value in a range of pixel values that are present in the source image signal.

In a case that the image is coded, the coding distortion may cause the prediction image to have a pixel value in the range of pixel values that are not present in the source image signal. According to the loop filter 107 of the present embodiment, in a case that the prediction image has a pixel value in the range of pixel values that are not present in the source image signal, the pixel value can be modified to a value in a range of pixel values that are present in the source image, thereby improving the prediction efficiency.

Also, generally, unnatural color blocks may occur in a case that the coded image cannot be decoded correctly. According to the loop filter 305 of the present embodiment, the occurrence of the color block can be prevented. That is, according to the loop filter 305 of the present embodiment, error tolerance in decoding an image can be improved.

### Modification 1

Although the present embodiment illustrates an example in which a value limiting filter is applied to an image coding apparatus and an image decoding apparatus as a loop filter, the value limiting filter does not necessarily need to be present inside the coding loop and may be implemented as a post filter. Specifically, the loop filters 107 and 305 are configured to be applied to the decoded image rather than being anterior to the reference picture memories 109 and 306.

### Modification 2

A part or all of the image coding apparatus 11 and the image decoding apparatus 31 in the embodiments described above may be realized as an integrated circuit such as a Large Scale Integration (LSI). Each function block of the image coding apparatus 11 and the image decoding apparatus 31 may be individually realized as processors, or part or all may be integrated into processors. The circuit integration technique is not limited to LSI, and may be realized as dedicated circuit or multi-purpose processor. In a case that with advances in semiconductor technologY, a circuit integration technologY with which an LSI is replaced appears, an integrated circuit based on the technologY may be used.

The embodiment of the present disclosure has been described in detail above referring to the drawings, but the specific configuration is not limited to the above embodiments and various amendments can be made to a design that fall within the scope that does not depart from the gist of the present disclosure.

### Second Embodiment

Hereinafter, other embodiment of the present disclosure will be described with reference to the drawings. Note that, for the sake of convenience of description, members having the same functions as the members described in the above embodiment are denoted by the same reference signs, and descriptions thereof will not be repeated. In the present embodiment, a value limiting filter processing unit that processes luminance signals and chrominance signals separately will be described.

### First Example

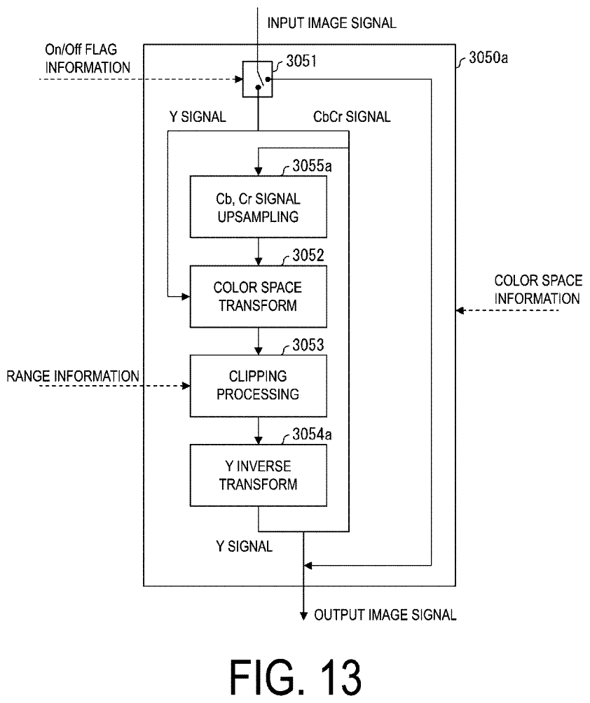

FIG. 13 is a diagram illustrating a configuration of a value limiting filter processing unit 3050a (a value limiting filter apparatus) for luminance signals. As illustrated in FIG. 13, the value limiting filter processing unit 3050a includes a switch unit 3051, a Cb/Cr signal upsampling processing unit 3055a (an upsampling processing unit), a color space transform processing unit 3052, a clipping processing unit 3053, and a Y inverse transform processing unit 3054a (a color space inverse transform processing unit 3054).

The switch unit 3051 switches whether to perform value limiting clipping processing based on On/Off flag information. The On/Off flag information corresponds to slice_colour_space_clipping_luma_flag and csc_luma_flag in the syntax illustrated in FIGS. 11 and 12.

In the Cb/Cr signal upsampling processing unit 3055a, an upsampling processing is performed on chrominance signals Cb and Cr, and the number of pixels in the chrominance signals Cb and Cr is caused to match the number of pixels in the luminance signal. The color space transform processing unit 3052 performs a color space transform on input signals of Y, Cb, and Cr based on color space information. Here, the color space information is color space information by VUI indicated by vui_information_use_flag on the syntax of FIG. 11 or default color space information. The clipping processing unit 3053 performs clipping processing on the signal that has been color transformed by the color space transform processing unit 3052, based on the range information. The range information is defined as illustrated in (c) of FIG. 11. The Y inverse transform processing unit 3054a performs color space inverse transform only on the luminance signal Y among signals resulting from the clipping processing by the clipping processing unit 3053 and outputs a resulting signal as an output image signal along with Cb and Cr signals of the input image signal. The contents of the color space inverse transform are the same as the contents described for the color space inverse transform processing unit 3054.

### Second Example

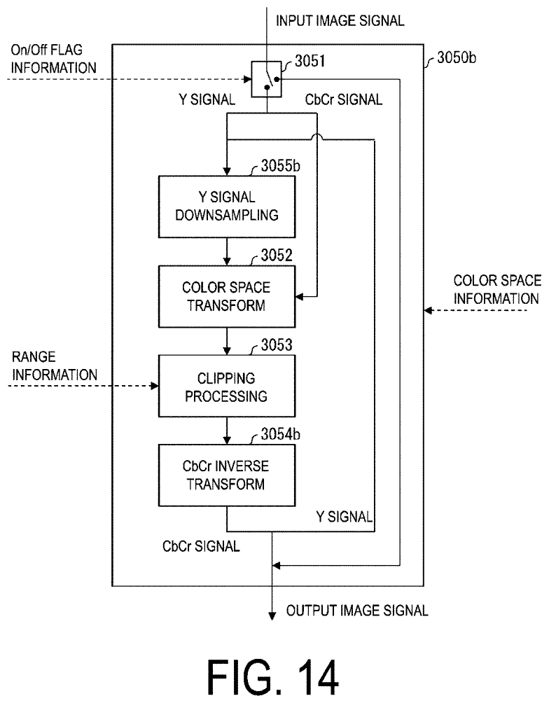

FIG. 14 is a diagram illustrating a configuration of a value limiting filter processing unit 3050b (a value limiting filter apparatus) for chrominance signals. As illustrated in FIG. 14, the value limiting filter processing unit 3050b includes a switch unit 3051, a Y signal downsampling processing unit 3055b (a downsampling processing unit), a color space transform processing unit 3052, a clipping processing unit 3053, and a Cb/Cr inverse transform processing unit 3054b.

The switch unit 3051 switches whether to perform value limiting clipping processing based on the On/Off flag information. The On/Off flag information corresponds to slice_colour_space_clipping_chroma_flag and csc_chroma_flag in the syntax illustrated in FIGS. 11 and 12.

The Y signal downsampling processing unit 3055b performs downsampling processing on the luminance signal Y to cause the luminance signal to match the number of pixels. The color space transform processing unit 3052 performs a color space transform on input signals of Y, Cb, and Cr based on the color space information. Here, the color space information is color space information by VUI indicated by vui_information_use_flag on the syntax of FIG. 11 or default color space information. Next, the clipping processing unit 3053 performs clipping processing on the color-transformed signals based on the range information. The range information is defined as illustrated in (c) of FIG. 11. Finally, the Cb/Cr inverse transform processing unit 3054b performs color space inverse transform on the chrominance signals Cb and Cr from the color space-transformed signals resulting from the clipping processing, and outputs the chrominance signals Cb and Cr as output image signals along with the Y signal serving as the input signal. The contents of the color space inverse transform are the same as the contents described for the color space inverse transform processing unit 3054.

### Third Example

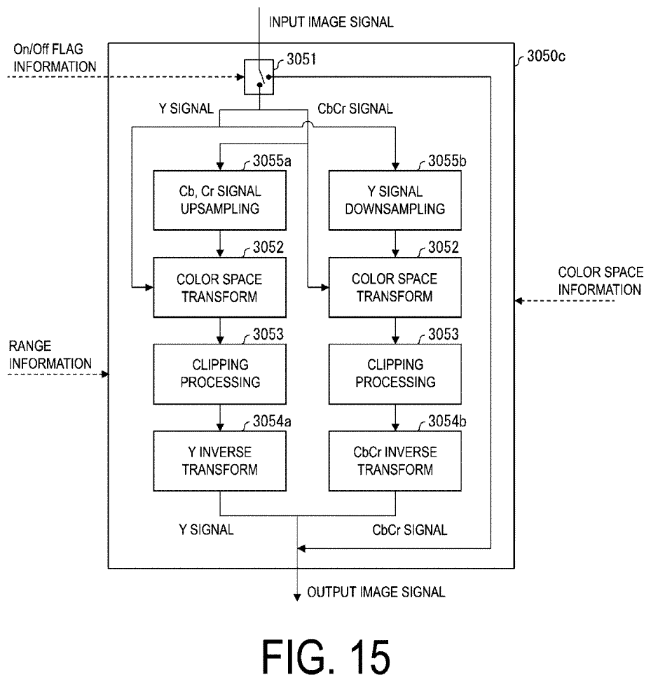

FIG. 15 is a diagram illustrating a configuration of a value limiting filter processing unit 3050c (a value limiting filter apparatus) for luminance and chrominance signals. The value limiting filter processing unit 3050c is different from the value limiting filter processing unit 3050a and the value limiting filter processing unit 3050b, and the On/Off flag information is common to the luminance signal Y and the chrominance signals Cb and Cr. The value limiting filter processing unit 3050c includes a switch unit 3051, a Cb/Cr signal upsampling processing unit 3055a, a Y signal downsampling processing unit 3055b, a color space transform processing unit 3052, a clipping processing unit 3053, a Y inverse transform processing unit 3054a, and a Cb/Cr inverse transform processing unit 3054b. The operation of each configuration is the same as the operation described above with reference to FIG. 13 or FIG. 14. After clipping processing is performed, the value limiting filter processing unit 3050c outputs the Y signal and the Cb and Cr signals resulting from the color space inverse transform as output image signals. The contents of the color space inverse transform are the same as the contents described for the color space inverse transform processing unit 3054.

### Downsampling of Y Signal and Upsampling of Cb and Cr Signals

Several methods can be applied to downsampling of the Y signal by the Y signal downsampling processing unit 3055b and upsampling of the Cb and Cr signals by the Cb/Cr signal upsampling processing unit 3055a.

Examples of the methods include a form of method that causes the number of pixels of Y to match the number of pixels of Cb and Cr by using a linear upsampling filter and downsampling filter. Specifically, the Y signal downsampling processing unit 3055b performs low-pass filtering processing on the pixels of each Y signal included in the input image signal by using the pixels of the Y signal at spatially surrounding positions, then processing unit decimates the pixels of the Y signal, and then causes the number of pixels of the Y signal to match the number of pixels of the Cb and Cr signals. In addition, the Cb/Cr signal upsampling processing unit 3055a interpolates the Cb and Cr signals from the pixels of the Cb and Cr signals at spatially surrounding positions for each pixel of the Cb and Cr signals included in the input image signal to increase the number of pixels of the Cb and Cr signals, and thus causes the number of pixels of the Cb and Cr signals to match the number of pixels of the Y signal

Examples of the methods include another form of method that causes the number of pixels of the Y signal to match the number of pixels of the Cb and Cr signals by using a median filter. Specifically, the Y signal downsampling processing unit 3055b decimates the pixels of the Y signal by performing the median filtering processing on the pixels of each Y signal included in the input image signal by using the pixels of the Y signal at spatially surrounding positions, and causes the number of pixels of the Y signal to match the number of pixels of the Cb and Cr signals. In addition, the Cb/Cr signal upsampling processing unit 3055a interpolates the pixels of the Cb and Cr signals from the pixels at spatially surrounding positions for each pixel of the Cb and Cr signals included in the input image signal to increase the number of pixels, and causes the number of pixels of the Cb and Cr signals to match the number of pixels of the Y signal.

In another form of method, the Y signal downsampling processing unit 3055b selects and decimates a pixel of a specific Y signal among the pixels included in the input image signal to cause the number of pixels of the Y signal to match the number of pixels the Cb and Cr signals. In addition, the Cb/Cr signal upsampling processing unit 3055a replicates each of the pixels of the Cb and Cr signals included in the input image signal to generate the pixels of the Cb and Cr signals having the same pixel values as the pixels of the Cb and Cr signals included in the input image signal, thus increasing the number of pixels of the Cb and Cr signals to cause the number of pixels of the Cb and Cr signals to match the number of pixels of the Y signal.

### Effects

As described above, the value limiting filter processing units 3050a, 3050b and 3050c of the present embodiment include at least one of the Cb/Cr signal upsampling processing unit 3055a and the Y signal downsampling processing unit 3055b. This configuration allows the value limiting filter processing units 3050a, 3050b, and 3050c to perform the value limiting filtering processing even in a case that the number of pixels of the luminance signal Y and the number of pixels of the chrominance signals Cb and Cr are different in the input image signal.

### Third Embodiment

International standards, such as BT.709 and BT.2100, that are generally used in color space transform processing are defined with real values. However, calculation using real values are more likely to be complicated. In addition, in calculation using real values, a calculation error caused by the floating point may occur. In a case that the calculation error occurs, decoded images of the image coding apparatus and the image decoding apparatus may not match each other.

Thus, in the present embodiment, color space transform processing is defined with integers. By defining the processing with integers, calculation can be simplified. In addition, because the floating point does not occur, it is possible to prevent the calculation error caused by the floating point from occurring.

Note that, in the present embodiment, it is assumed that a predetermined color space (for example, a color space based on Video Usability Information (VUI)) is used as color space information.

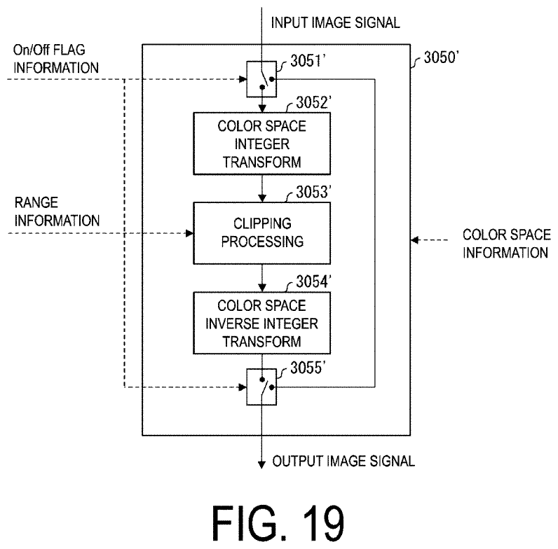

First, FIG. 19 illustrates a configuration of a value limiting filter processing unit 3050′ according to the present embodiment. FIG. 19 is a block diagram illustrating a configuration of the value limiting filter processing unit 3050′. As illustrated in FIG. 19, the value limiting filter processing unit 3050′ includes a switch unit 3051′, a color space integer transform processing unit 3052′(first transform processing unit), a clipping processing unit 3053′(a limiting unit), a color space inverse integer transform processing unit 3054′(second transform processing unit), and a switch unit 3055′.

The switch unit 3051′ switches whether to perform processing by the color space integer transform processing unit 3052′, the clipping processing unit 3053′, the color space inverse integer transform processing unit 3054′, and the switch unit 3055′. In the following description, processing by the color space integer transform processing unit 3052′, the clipping processing unit 3053′, the color space inverse integer transform processing unit 3054′, and the switch unit 3055′ may be referred to as value limiting filtering. The switch unit 3051′ performs the above switching based on the On/Off flag transmitted from the entropy decoder 301. More particularly, in a case that the switch unit 3051′ determines that at least any one of On/Off flags of a slice level “slice_colour_space_clipping_luma_flag,” “slice_colour_space_clipping_cb_flag,” and “slice_colour_space_clipping_cr_flag” is 1 (ON), the value limiting filter processing unit 3050′ executes value limiting filtering processing. On the other hand, in a case that all of the On/Off flags of the slice level are 0 (OFF), the value limiting filter processing unit 3050′ does not perform the value limiting filtering processing. Thus, in this case, the image input signal input to the value limiting filter processing unit 3050′ is output as it is.

The color space integer transform processing unit 3052′ transforms the input image signal defined by a certain color space into an image signal of another color space by using an integer coefficient (first transform). The transform of the image signal is performed based on color space information described in the slice header level of the input image signal. In a case that the input image signal conforms to ITU-R BT.709, for example, the color space integer transform processing unit 3052′ transforms the input image signal of a YCbCr space into an image signal of an RGB space.

In the present embodiment, the color space integer transform processing unit 3052′ performs a color space transform according to the following formulas.

First, the color space integer transform processing unit 3052′ aligns bit lengths of pixel values in the color space by using the following formulas.

Y=Y*(1<<(BitDepth−BitDepthY))

Cb=Cb*(1<<(BitDepth−BitDepthC))

Cr=Cb*(1<<(BitDepth−BitDepthC))

Next, a YCbCr to RGB transform is performed using the following formulas.

R=(R₁*Y+R₂*Cb+R₃*Cr+R₄+(1<<(SHIFT−1)))>>SHIFT

G=(G₁*Y+G2*Cb+G3*Cr+G₄+(1<<(SHIFT−1)))>>SHIFT

B=(B₁*Y+B₂*Cb+B₃*Cr+B₄+(1<<(SHIFT−1)))>>SHIFT

Here, BitDepth=max (BitDepthY, BitDepthC) is satisfied, BitDepthY is a pixel bit length of a luminance signal (greater than or equal to 8 bits and less than or equal to 16 bits), and BitDepthC is a pixel bit length of a chrominance signal (greater than or equal to 8 bits and equal to or less than 16 bits). In addition, SHIFT=14−max (0, BitDepth−12) is satisfied.

In addition, R₁ to R₄, G₁ to G₄, and B₁ to B₄ are integer coefficients expressed by the following formulas.

R₁=Round(t₁)

R₂=0

R₃=Round(t₂)

R₄=Round(−t₁*(16<<(BitDepth−8))−t₂*(1<<(BitDepth−1)))

G₁=Round(t₁)

G₂=Round(t₃)

G₃=Round(t₄)

G₄=Round(−t₁*(16<<(BitDepth−8))−(t₃+t₄)*(1<<(BitDepth−1)))

B₁=Round(t₁)

B₂=Round(t₅)

B₃=0

B₄=Round(−t₁*(16<<(BitDepth−8))−t₅*(1<<(BitDepth−1)))

Here, t₁, t₂, t₃, t₄, and t₅ are real variables and values expressed using the following formulas.

t₁=(255*(1<<SHIFT))/219

t₂=(255*(1<<SHIFT))*(1−Kr)/112

t₃=−(255*(1<<SHIFT))*Kb*(1−Kb)/(112*Kg)

t₄=−(255*(1<<SHIFT))*Kr*(1−Kr)/(112*Kg)

t₅=(255*(1<<SHIFT))*(1−Kb)/112

In a case of ITU-R BT.709, Kr=0.2126, Kg=0.7152, Kb=0.0722 are satisfied, and in case of BT.2100, Kr=0.2627, Kg=0.6780, and Kb=0.0593 are satisfied.

In addition, a rounding function Round (x)=Sign (x)*Floor (Abs(x)+0.5) is satisfied. Here, Sign (x) is a function of outputting the sign of x.

The clipping processing unit 3053′ performs processing for limiting the pixel value on the image signal transformed by the color space integer transform processing unit 3052′. That is, the clipping processing unit 3053′ modifies the pixel value of the image signal to a pixel value within a range defined by the range information transmitted from the entropy decoder 301.

Specifically, the clipping processing unit 3053′ performs the following processing on pixel values R, G, and B by using minimum values Rmin, Gmin, and Bmin, and maximum values Rmax, Gmax, and Bmax included in the range information.

If (R<R min∥R>R max∥G<G min∥G>G max|B<B min|B>B max)

{

R = Clip3 (Rmin, Rmax, R)
G = Clip3 (Gmin, Gmax, G)
B = Clip3 (Bmin, Bmax, B)

}

where

R min=0, G min=0, B min=0

R max=(1<<BitDepth)−1, G max=(1<<BitDepth)−1, B max=(1<<BitDepth)−1.

That is, the clipping processing unit 3053′ modifies the pixel value to a value equal to the minimum value in a case that the pixel value (R, G, and B) is less than the minimum value (Rmin, Gmin, and Bmin). In addition, in a case that the pixel value is greater than the maximum value (Rmax, Gmax, and Bmax), the clipping processing unit 3053′ modifies the pixel value to a value equal to the maximum value. The clipping processing unit 3053′ does not modify the pixel value in a case that the pixel value is greater than the minimum value and less than the maximum value.

The color space inverse integer transform processing unit 3054′ performs an inverse transform on the image signal having a pixel value limited by the clipping processing unit 3053′ into an image signal of the original color space (second transform). The inverse transform is performed based on the color space information, similarly to the transform by the color space transform processing unit 3052. In a case that the input image signal conforms to ITU-R BT.709, for example, the color space inverse integer transform processing unit 3054′ transforms the image signal of the RGB space into an image signal of the YCbCr space.

In the present embodiment, the color space inverse integer transform processing unit 3054′ performs a color space transform according to the following formulas.

Cb=(C₁*R+C₂*G+C₃*B+(1<<(SHIFT+BitDepth−BitDepthC−1)))>>(SHIFT+BitDepth−BitDepthC)+C₄

Cr=(C₅*R+C₆*G+C₇*B+(1<<(SHIFT+BitDepth−BitDepthC−1)))>>(SHIFT+BitDepth−BitDepthC)+C₈

Y=*R+Y₂*G+Y₃*B+(1<<(SHIFT+BitDepth−BitDepthY−1)))>>(SHIFT+BitDepth−BitDepthY)+Y₄

where

C₁=Round(((−Kr*112)*(1<<SHIFT))/((1−Kb)*255)))

C₂=Round(((−Kg*112)*(1<<SHIFT))/((1−Kb)*255))

C₃=Round((((1−Kb)*112)*(1<<SHIFT))/((1−Kb)*255))

C₄=1<<(BitDepthC−1)

C₅=Round((((1−Kr)*112)*(1<<SHIFT))/((1−Kr)*255)))

C₆=Round(((−Kg*112)*(1<<SHIFT))/((1−Kr)*255))

C₇=Round(((−Kb*112)*(1<<SHIFT))/((1−Kr)*255))

C₈=1<<(BitDepthC−1)

Y₁=Round((−Kr*219)*(1<<SHIFT)/255)

Y₂=Round((−Kg*219)*(1<<SHIFT)/255)

Y₃=Round((−Kb*219)*(1<<SHIFT)/255), and

Y₄=16<<((BitDepthY−8).

The switch unit 3055′ switches whether the inversely transformed pixel value is to be used by the color space inverse integer transform processing unit 3054′. Then, in a case that the inversely transformed pixel value is used, a pixel value resulting from the value limiting filtering is output instead of the input pixel value, and in a case that the inversely transformed pixel value is not used, the input pixel value is output as it is. Whether the inversely transformed pixel value is used is determined based on the On/Off flag transmitted from the entropy decoder 301.

Specifically, in a case that “slice_colour_space_clipping_luma_flag” which is an On/Off flag of the slice level is 1 (ON), the switch unit 3055′ uses the pixel value obtained by inversely transforming the pixel value Y indicating luminance and in a case that the flag is 0 (OFF), the input pixel value Y is used. Similarly, in a case that “slice_colour_space_clipping_cb_flag” is 1 (ON), the pixel value obtained by inversely transforming the pixel value Cb indicating chrominance is used, and in a case that the flag is 0 (OFF), the input pixel value Cb is used. In addition, “slice_colour_space_clipping_cr_flag” is 1 (ON), the pixel value obtained by inversely transforming the pixel value Cr indicating chrominance is used, and in a case that the flag is 0 (OFF), the input pixel value Cr is used.

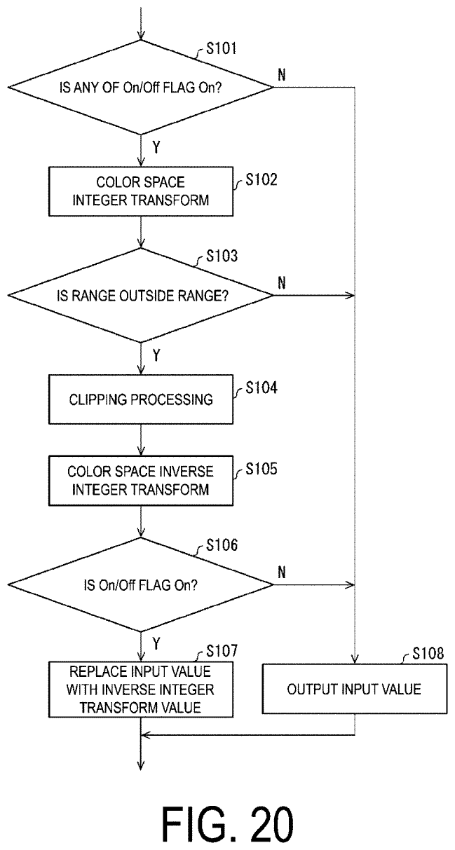

Next, the flow of processing of the value limiting filter processing unit 3050′ will be described with reference to FIG. 20. FIG. 20 is a flowchart illustrating the flow of processing of the value limiting filter processing unit 3050′.

As illustrated in FIG. 20, in a case that at least one of the On/Off flags of the slice level is On (YES in step 101), the switch unit 3051′ of the value limiting filter processing unit 3050′ transmits the input image signal in a direction that causes the value limiting filtering processing to be performed, that is, in the direction toward the color space integer transform processing unit 3052′. On the other hand, in a case that all of the On/Off flags of the slice level are Off (NO in S101), the switch unit 3051′ transmits the pixel value of the input image signal in a direction that causes the value limiting filtering processing not to be performed, that is, in the direction that causes the pixel value of the input image signal to be output as it is (S108).

Next, the color space integer transform processing unit 3052′ performs color space integer transform on the input image signal (S102). Then, the clipping processing unit 3053′ determines whether the pixel value of the image signal resulting from the color space transform is within the range of the range (S103), and performs clip processing (S104) in a case that the pixel value is outside the range of the range (YES in S103). On the other hand, in a case that the pixel value is within the range of the range (NO in S103), the process proceeds to step S108, and the pixel value of the input image signal is output as it is.

Next, the color space inverse integer transform processing unit 3054′ performs a color space inverse integer transform on the clipped pixel value (S105).

Next, the switch unit 3055′ determines whether to use the inverse transformed value or to use the pixel value of the input image signal as a pixel value based on the value of the On/Off flag of the slice level corresponding to each transformed pixel value (Y, Cb, Cr) (S106). That is, in a case that the value of the On/Off flag of the corresponding slice level is 1 (YES in S106), the inversely transformed pixel value is output instead of the pixel value of the input image signal (S107). On the other hand, in a case that the value of the On/Off flag of the corresponding slice level is 0 (NO in S106), the pixel value of the input image signal is output as it is (S108). Note that, in a case of NO in step S103, the pixel value of the input image signal is output as it is.

As described above, the color space integer transform processing unit 3052′(first transform processing unit) and the color space inverse integer transform processing unit 3054′(second transform processing unit) of the value limiting filter processing unit 3050′ (value limiting filter apparatus) according to the present embodiment performs calculation by multiplication, addition, and shift operations of integers in transform processing for transforming the color space.

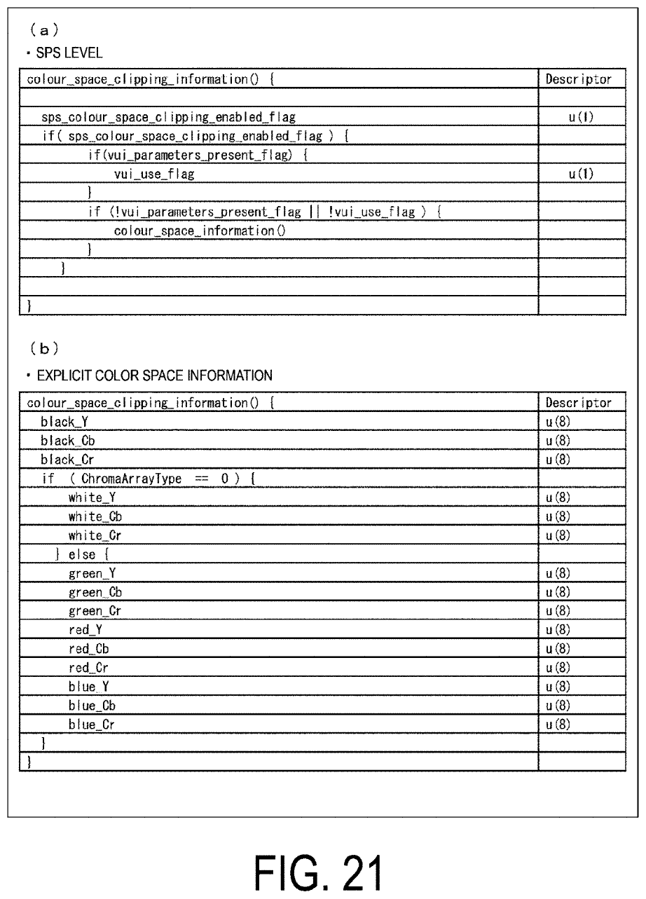

(a) of FIG. 21 is a data structure of syntax of SPS level information. In the present embodiment, whether to use predetermined color space information is determined using vui_use_flag included in the SPS level information. Note that, in a case that the predetermined color space information is not used, information explicitly indicating a color space is transmitted. Although this configuration will be described below as Embodiment 4, the data structure of the syntax thereof is as illustrated in (b) of FIG. 21.

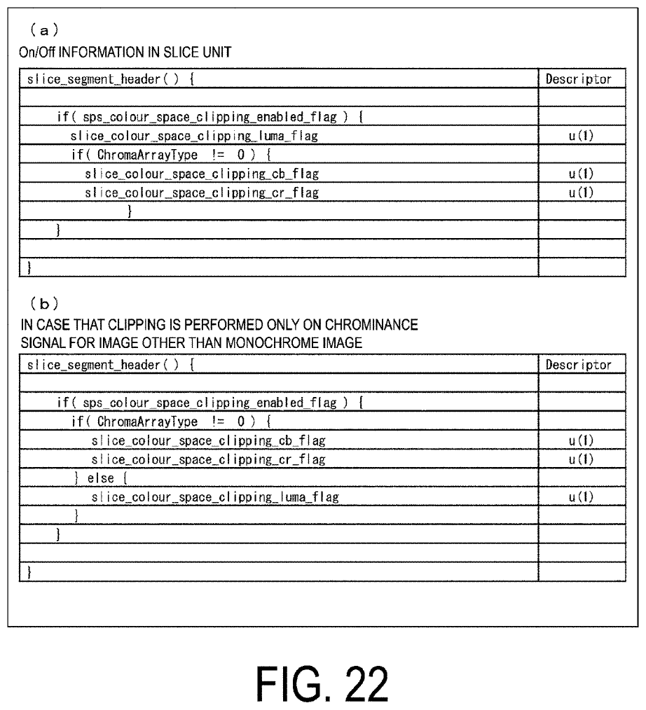

(a) of FIG. 22 is a data structure of syntax of slice header level information. In this embodiment, using values of slice_colour_space_clipping_luma_flag, slice_colour_space_clipping_cb_flag, and slice_colour_space_clipping_cr_flag of the slice header level information, processing of the switch unit 3051′ is switched. That is, in a case that any one of the values of slice_colour_space_clipping_luma_flag, slice_colour_space_clipping_cb_flag, slice_colour_space_clipping_cr_flag is 1, the switch unit 3051′ transmits the input image signal to the color space integer transform processing unit 3052′. On the other hand, in a case that all of the values is 0, the switch unit 3051′ outputs the input image signal as it is.

Note that the clipping processing unit 3053′ may clip only the chrominance signal in a case that the input image signal indicates an image other than a monochrome image. In this case, the data structure of syntax of the slice header level information is as illustrated in (b) of FIG. 22.

In other words, the clipping processing unit 3053′(limiting unit) of the value limiting filter processing unit 3050′(value limiting filter apparatus) may perform processing of limiting the pixel value for only the image signal indicating chrominance in the input image signal in a case that the input image signals indicate images other than monochrome images.

As described above, the first transform processing unit (the color space integer transform processing unit 3052′) and the second transform processing unit (the color space inverse integer transform processing unit 3054′) of value limiting filter apparatus (the value limiting filter processing unit 3050′) according to the present embodiment is characterized in that they perform calculation by multiplication, addition, and shift operations of integers in transform processing for transforming the color space.

This allows the transform processing of the color space to be defined with integers because the transform processing of the color space is calculated by multiplication, addition, and shift operations of the integers. Since this allows calculation processing to be simplified, and unlike the case defined with real numbers the floating point does not occur, it is possible to prevent a calculation error caused by the floating point from occurring.

Furthermore, in a case that the input image signal indicates the image other than the monochrome image, the limiting unit (the clipping processing unit 3053) is characterized in that it performs the limiting processing on the pixel value for only the image signal indicating chrominance in the input image signal.

This allows the processing to be reduced because, in a case of the image other than the monochrome image, the processing for limiting the pixel value is applied only to the image signal indicating chrominance.

### Fourth Embodiment

In the present embodiment, color space transform processing is defined with integers, color space information is explicitly defined, and the defined color space information is included in coded data. This causes the color space transform processing to be defined with integers, so calculation can be simplified similarly to the third embodiment. In addition, because the floating point does not occur, it is possible to prevent a calculation error caused by the floating point from occurring. In addition, user-defined color space information can be used.

Note that, in the present embodiment, it is assumed that a color space of YCbCr is used as color space information. In addition, since a configuration and flow of processing of the value limiting filter processing unit 3050′ in the present embodiment are the same as those of the third embodiment described above, the present embodiment will be described with reference to FIGS. 19 and 20 used to describe the third embodiment.

Processing of Color Space Integer transform processing unit 3052′

In the present embodiment, the color space integer transform processing unit 3052′ performs a color space transform according to the following formulas. First, the color space integer transform processing unit 3052′ aligns bit lengths of pixel values in the color space by using the following formulas.

BitDepth=max(BitDepthY,BitDepthC)

Y=Y*(1<<(BitDepth−BitDepthY))

Cb=Cb*(1<<(BitDepth−BitDepthC))

Cr=Cb*(1<<(BitDepth−BitDepthC))

Y_{K}=Y_{K}*(1<<(BitDepth−8)

CbK=CbK*(1<<(BitDepth−8))

Cr_{K}=Cb_{K}*(1<<(BitDepth−8))

Y_{R}=Y_{R}*(1<<(BitDepth−8))

Cb_{R}=Cb_{R}*(1<<(BitDepth−8))

CrR=Cb_{R}*(1<<(BitDepth−8))

Y_{G}=Y_{G}*(1<<(BitDepth−8))

Cb_{G}=Cb_{G}*(1<<(BitDepth−8))

Cr_{G}=Cb_{G}*(1<<(BitDepth−8))

Y_{B}=Y_{B}*(1<<(BitDepth−8))

Cb_{B}=Cb_{B}*(1<<(BitDepth−8))

Cr_{B}=Cb_{B}*(1<<(BitDepth−8))

Next, the color space is defined from the following four points (black, red, green, blue) of the YCbCr space.

Black: K(Y_{K},Cb_{K},Cr_{K})

Red: R(Y_{R},Cb_{R},Cr_{R})

Green: G(Y_{G},Cb_{G},Cr_{G})

Blue: B(Y_{B},Cb_{B},Cr_{B})

First, three vectors from the four points described above are obtained using the following formulas.

RK=(Y_{R}−Y_{K},Cb_{R}−Cb_{K},Cr_{R}−Cr_{K})

GK=(Y_{G}−Y_{K},Cb_{G}−Cb_{K},Cr_{G}−Cr_{K})

BK=(Y_{B}−Y_{K},Cb_{B}−Cb_{K},Cr_{B}−Cr_{K})

Next, three normal vectors from the three vectors described above are obtained using the following formulas. Note that “x” indicates an outer product.

GK×BK=(r_{Y},r_{Cb},r_{Cr})=((Cb_{G}−Cb_{K})(Cr_{B}−Cr_{K})−(Cb_{B}−Cb_{K})(Cr_{G}−Cr_{K}),−(Y_{G}−Y_{K})(Cr_{B}−Cr_{K})+(Y_{B}−Y_{K})(Cr_{G}−Cr_{K}),(Y_{G}−Y_{K})(Cb_{B}−Cb_{K})−(Y_{B}−Y_{K})(Cb_{G}−Cb_{K}))

BK×RK=(g_{Y},g_{Cb},g_{Cr})=((Cb_{B}−Cb_{K})(Cr_{R}−Cr_{K})−(Cb_{R}−Cb_{K})(Cr_{B}−Cr_{K}),−(Y_{B}−Y_{K})(Cr_{R}−Cr_{K})+(Y_{R}−Y_{K})(Cr_{B}−Cr_{K}),(Y_{B}−Y_{K})(Cb_{R}−Cb_{K})−(Y_{R}−Y_{K})(Cb_{B}−Cb_{K}))

RK×GK=(b_{Y},b_{Cb},b_{Cr})=((Cb_{R}−Cb_{K})(Cr_{G}−Cr_{K})−(Cb_{G}−Cb_{K})(Cr_{R}−Cr_{K}),−(Y_{R}−Y_{K})(Cr_{G}−Cr_{K})+(Y_{G}−Y_{K})(Cr_{R}−Cr_{K}),(Y_{R}−Y_{K})(Cb_{G}−Cb_{K})−(Y_{G}−Y_{K})(Cb_{R}−Cb_{K}))

Next, a YCbCr to RGB transform is performed using the following formulas.

R=(r_{Y}(Y−Y_{K})+r_{Cb}(Cb−Cb_{K})+r_{Cr}(Cr−Cr_{K})+(1<<(SHIFT−1)))>>SHIFT

G=(g_{Y}(Y−Y_{K})+g_{Cb}(Cb−Cb_{K})+g_{Cr}(Cr−Cr_{K})+(1<<(SHIFT−1)))>>SHIFT

B=(b_{Y}(Y−Y_{K})+b_{Cb}(Cb−Cb_{K})+b_{Cr}(Cr−Cr_{K})+(1<<(SHIFT−1)))>>SHIFT

where

r_{Y}=Round(r_{Y}*(1<<SHIFT)/r_{Y})

r_{Cb}=Round(r_{Cr}*(1<<SHIFT)/r_{Y})

r_{Cr}=Round(r_{Cr}*(1<<SHIFT)/r_{Y})

g_{Y}=Round(g_{Y}*(1<<SHIFT)/g_{Y})

g_{Cb}=Round(g_{Cr}*(1<<SHIFT)/g_{Y})

g_{Cr}=Round(g_{Cr}*(1<<SHIFT)/g_{Y})

b_{Y}=Round(b_{Y}*(1<<SHIFT)/b_{Y})

b_{Cb}=Round(b_{Cr}*(1<<SHIFT)/b_{Y}), and

b_{Cr}=Round(b_{Cr}*(1<<SHIFT)/b_{Y}).

Note that the YCbCr to RGB transform may be performed using the following formulas.

R=((Y−Y_{K})+(r_{Cb}(Cb−Cb_{K})+r_{Cr}(Cr−Cr_{K})+(1<<(SHIFT−1))))>>SHIFT

G=((Y−Y_{K})+(g_{Cb}(Cb−Cb_{K})+g_{Cr}(Cr−Cr_{K})+(1<<(SHIFT−1))))>>SHIFT

B=((Y−Y_{K})+(b_{Cb}(Cb−Cb_{K})+b_{Cr}(Cr−Cr_{K})+(1<<(SHIFT−1))))>>SHIFT

### Processing of Clipping Processing Unit 3053′

In the present embodiment, the clipping processing unit 3053′ performs the following processing for pixel values R, G, and B by using the minimum values Rmin, Gmin, Bmin, and the maximum values Rmax, Gmax, and Bmax included in the range information.

If (R<R min∥R>R max∥G<G min∥G>G max∥B<B min∥B>B max)

{
R = Clip3 (Rmin, Rmax, R)
G = Clip3 (Gmin, Gmax, G)
B = Clip3 (Bmin, Bmax, B)
}

where

R min=0, G min=0, B min=0

R max=(r_{Y}(Y_{R}−Y_{K})+r_{Cb}(Cb_{R}−Cb_{K})+r_{Cr}(Cr_{R}−Cr_{K})+(1<<(SHIFT−1)))>>SHIFT

G max=(g_{Y}(Y−Y_{K})+g_{Cb}(Cb−Cb_{K})+g_{Cr}(Cr−Cr_{K})+(1<<(SHIFT−1)))>>SHIFT,

and

B max=(b_{Y}(Y−Y_{K})+b_{Cb}(Cb−Cb_{K})+b_{Cr}(Cr−Cr_{K})+(1<<(SHIFT−1)))>>SHIFT.

### Processing of Color Space Inverse Integer Transform Processing Unit 3054′

In the present embodiment, the color space inverse integer transform processing unit 3054′ performs an inverse transform of a color space in accordance with the following transformation matrix and matrix equation.

$$\begin{matrix}TRANSFORMATION MATRIX & Expression 2 \\ D = ( \begin{matrix}{r}_{Y} & {r}_{C b} & {r}_{C r} \\ {g}_{Y} & {g}_{Cb} & {g}_{C r} \\ {b}_{Y} & {b}_{Cb} & {b}_{C r}\end{matrix} ) & \\ MATRIX EQUATION & Expression 3 \\ \vert D \vert = \vert \begin{matrix}{r}_{Y} & {r}_{C b} & {r}_{C r} \\ {g}_{Y} & {g}_{Cb} & {g}_{C r} \\ {b}_{Y} & {b}_{Cb} & {b}_{C r}\end{matrix} \vert & \\ ( \begin{matrix}Y \\ C b \\ Cr\end{matrix} ) = \frac{1}{\vert D \vert} ( \begin{matrix}{D}_{11} & {D}_{21} & {D}_{31} \\ {D}_{12} & {D}_{22} & {D}_{32} \\ {D}_{13} & {D}_{23} & {D}_{33}\end{matrix} ) ( \begin{matrix}R \\ G \\ B\end{matrix} ) + ( \begin{matrix}{Y}_{K} \\ {Cb}_{K} \\ C {r}_{K}\end{matrix} ) & Expression 4\end{matrix}$$

where

D₁₁=gC_{b}b_{Cr}−g_{Cb}b_{Cb}

D₂₁=r_{Cr}b_{Cb}−r_{Cb}r_{Cr}

D₃₁=r_{Cb}g_{Cr}−r_{Cr}g_{Cb}

D₁₂=g_{Cr}b_{Y}−g_{Y}b_{Cr}

D₂₂=r_{Y}b_{Cr}−r_{Cr}b_{Y}

D₃₂=r_{Cr}g_{Y}−r_{Y}g_{Cr}

D₁₃=g_{Y}b_{Cb}−g_{Cb}b_{Y}

D₂₃=r_{Cb}b_{Y}−r_{Y}b_{Cb}

D₃₃=r_{Y}g_{Cb}−r_{Cb}g_{Y}.

That is, chrominance Cb and Cr are inversely transformed using the following formulas.

Cb=(C₁*R+C₂*G+C₃*B+(1<<(SHIFT−1)))>>(SHIFT+BitDepth−BitDepthC)+C₄

Cr=(C₅*R+C₆*G+C₇*B+(1<<(SHIFT−1)))>>(SHIFT+BitDepth−BitDepthC)+C₈

where

C₁=Round(D₁₂/(|D|>>(2*SHIFT)))

C₂=Round(D₂₂/(|D|>>(2*SHIFT)))

C₃=Round(D₃₂/(|D|>>(2*SHIFT)))

C₄=Cb_{K}(>>(BitDepth−BitDepthC)

C₅=Round(D₁₃/(|D|>>(2*SHIFT)))

C₆=Round(D₂₃/(|D|>>(2*SHIFT)))

C₇=Round(D₃₃/(|D|>>(2*SHIFT))), and

C₈=Cr_{K}>>(BitDepth−BitDepthC).

In addition, the luminance Y is inversely transformed using the following formula.

Y=(Y₁*R+Y₂*G+Y₃*B+(1<<(SHIFT−1)))>>(SHIFT+BitDepth−BitDepthY)+Y₄

where

Y₁=Round((D₁₁*(1<<SHIFT)/|D|)

Y₂=Round((D₂₁*(1<<SHIFT)/|D|)

Y₃=Round((D₃₁*(1<<SHIFT)/|D|), and

Y₄=Y_{K}>>(BitDepth−BitDepthY).

(b) of FIG. 21 illustrates a data structure of syntax of SPS level information. (b) of FIG. 21 illustrates information explicitly indicating a color space generated in a case of vui_use_flag=0 included in the SPS level information.

As described above, the limiting unit (the clipping processing unit 3053′) of the value limiting filter apparatus (the value limiting filter processing unit 3050′) according to the present embodiment is characterized in that they performs the above-described limiting based on whether the pixel value of the image signal transformed by the first transform processing unit (the color space integer transform processing unit 3052′) is included in a color space formed using four points that are predetermined.

This allows the limiting processing to be performed by using the color space generated using the four points that are specified in advance.

Furthermore, the color space formed using the four points described above is characterized in that it is a parallelepiped.

Furthermore, the four points are points indicating black, red, green, and blue.

### Fifth Embodiment

In Adaptive Clipping Filter, the maximum and minimum values of the pixel value in the YcbCr color space is limited as described above. Such a limitation using the maximum and minimum values in the YCbCr space may not limit the pixel value appropriately because of the presence of the pixel value that is not used in the RGB space (pixel values with error). Therefore, in a case that there is a pixel value with an error in the RGB color space, there is a problem in that the pixel value becomes a significant error in a color space of RGB used for display, thus causing a result of subjective evaluation of a user who has viewed the display of the image indicated by the color space to be significantly degraded.

An aspect of the present disclosure has been made in view of the above problem, and an objective thereof is to provide a technique for prevent degradation of image quality caused by the presence of a pixel value with an error in a color space.

A fifth embodiment of the present disclosure will be described as follows with reference to the drawings. Note that, for the sake of convenience of description, description of members having the same functions as the members described in the above embodiments will be omitted.

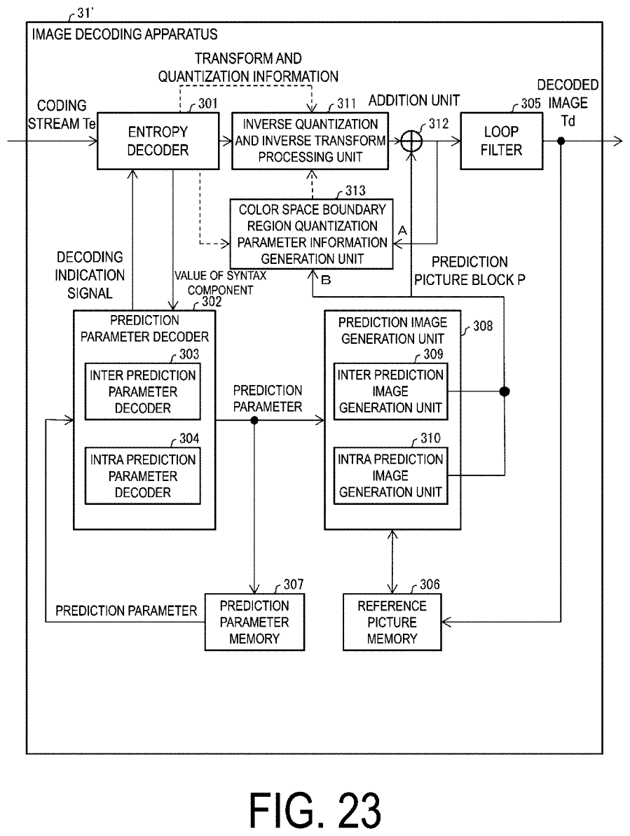

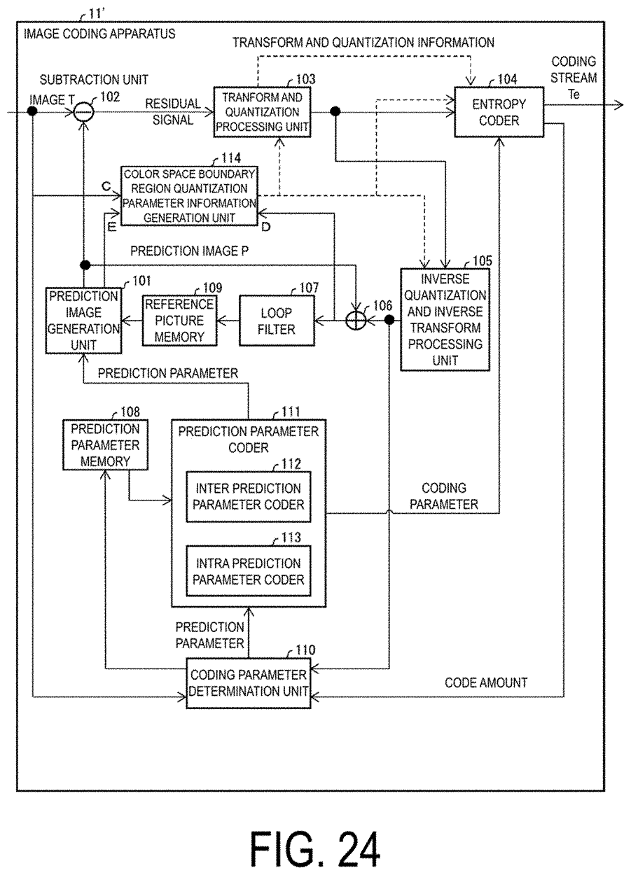

First, configurations of an image coding apparatus 11′ and an image decoding apparatus 31′ according to the present embodiment will be described. FIG. 23 is a block diagram illustrating a configuration of the image decoding apparatus 31′ according to the present embodiment. FIG. 24 is a block diagram illustrating a configuration of the image coding apparatus 11′ according to the present embodiment. As illustrated in FIG. 23, the image decoding apparatus 31′ according to the present embodiment further includes a color space boundary region quantization parameter information generation unit 313 in addition to the configuration of the image decoding apparatus 31 illustrated in FIG. 5. In addition, as illustrated in FIG. 24, the image coding apparatus 11′ according to the present embodiment further includes a color space boundary region quantization parameter information generation unit 114 in addition to the configuration of the image coding apparatus 11 illustrated in FIG. 4.

Color Space Boundary Region Quantization Parameter Information generation unit

The color space boundary region quantization parameter information generation unit 313 according to the present embodiment (hereinafter, a parameter generation unit 313) and the color space boundary region quantization parameter information generation unit 114 (hereinafter, a parameter generation unit 114) according to the present embodiment will be described below with reference to FIGS. 23 and 24.

Patterns of a quantization parameter configuration method performed by each of the parameter generation unit 313 and the parameter generation unit 114 include a case in which a quantization parameter is configured with reference to a source image signal, a case in which a quantization parameter is configured with reference to a decoded image signal of a neighboring pixel, and a case in which a quantization parameter is configured with reference to a prediction image signal.

As illustrated in FIG. 23, in a case that reference is made to the decoded image signal (arrow A in FIG. 23), the parameter generation unit 313 (a configuration unit in claims) determines whether a pixel value of a target block is included in a boundary region from a decoded image signal of a neighboring block (a coding unit (a quantization unit), for example, a CTU, a CU, or the like) of the target block generated by the addition unit 312. In a case that the pixel value is included in the boundary region, the color space boundary region quantization parameter information decoded by the entropy decoder 301 is used to derive a quantization parameter (QP2) that is different from a quantization parameter (QP1) for pixel values included in regions other than the boundary region.

Here, the QP1 is a quantization parameter derived using pic_init_qp_minus26 signaled in PPS, slice_qp_delta signaled in the slice header, cu_qp_delta_abs or cu_qp_delta_s.ign_flag signaled in a CU, or the like (color space boundary region quantization parameter information) In addition, the QP2 is a quantization parameter derived from the QP1 and pps_colour_space_boundary_luma_qp_offset or colour_space_boundary_luma_qp_offset (color space boundary region quantization parameter information) which will be described below, or a quantization parameter derived with reference to a table that maps the quantization parameter Q1 to the quantization parameter Q2.

The boundary region mentioned here will be described below. In addition, determination of whether a target block is included in the boundary region and a quantization parameter (QP2) are output to the inverse quantization and inverse transform processing unit 311. In a case that the parameter generation unit 313 determines that the pixel value of the target block is included in the boundary region, the inverse quantization and inverse transform processing unit 311 performs inverse quantization using the quantization parameter (QP2) derived by the parameter generation unit 313. Otherwise, inverse quantization is performed using the quantization parameter (QP1).

In a case that reference is made to a prediction image signal (arrow B in FIG. 23), the parameter generation unit 313 (a configuration unit in claims) determines whether the pixel value of the target block is included in the boundary region from the prediction image signal (coding unit (quantization unit)) of the target block generated by the prediction image generation unit 308, and in a case that the pixel value is included in the boundary region, the color space boundary region quantization parameter information decoded by the entropy decoder 301 is used to derive the quantization parameter (QP2) that is different from the quantization parameter (QP1) for pixel values included in regions other than the boundary region. In addition, determination of whether a target block is included in the boundary region and a quantization parameter (QP2) are output to the inverse quantization and inverse transform processing unit 311. An operation of the inverse quantization and inverse transform processing unit 311 is the same as the operation in the case that a decoded image signal is referred to.

As illustrated in FIG. 24, in a case that reference is made to a source image signal (arrow C in FIG. 24), the parameter generation unit 114 (a configuration unit in claims) determines whether the pixel value of the target block is included in the boundary region from the target block of an image T (coding unit (quantization unit)), and in a case that the pixel value of the target block is included in the boundary region, the quantization parameter (QP2) is derived that is different from the quantization parameter (QP1) for pixel values included in regions other than the boundary region. In addition, determination of whether the target block is included in the boundary region and color space boundary region quantization parameter information calculated from the quantization parameter (QP2) are output to the entropy coder 104. In addition, determination of whether the target block is included in the boundary region and the quantization parameter (QP2) are output to the transform and quantization processing unit 103 and the inverse quantization and inverse transform processing unit 105.

In a case that reference is made to the decoded image signal (arrow D in FIG. 24), the parameter generation unit 114 (a configuration unit in claims) determines whether the pixel value of the target block is included in the boundary region from the decoded image signal (coding unit (quantization unit)) of a neighboring block of the countermeasure block generated by the addition unit 106. In a case that the pixel value is included in the boundary region, the quantization parameter (QP2) is derived that is different from the quantization parameter (QP1) for pixel values included in regions other than the boundary region. In addition, the color space boundary region quantization parameter information calculated from the quantization parameter (QP2) is output to the entropy coder 104. In addition, determination of whether the target block is included in the boundary region and the quantization parameter (QP2) are output to the transform and quantization processing unit 103 and the inverse quantization and inverse transform processing unit 105.

In a case that reference is made to the prediction image signal (arrow E in FIG. 24), the parameter generation unit 114 (the configuration unit in the claims) determines whether the pixel value of the target block is included in the boundary region from the prediction image signal (coding unit (quantization unit)) of the target block generated by the prediction image generation unit 101. In a case that the pixel value is included in the boundary region, the quantization parameter (QP2) is derived that is different from the quantization parameter (QP1) for pixel values included in regions other than the boundary region. In addition, the color space boundary region quantization parameter information calculated from the quantization parameter (QP2) is output to the entropy coder 104. In addition, determination of whether the target block is included in the boundary region and the quantization parameter (QP2) are output to the transform and quantization processing unit 103 and the inverse quantization and inverse transform processing unit 105.

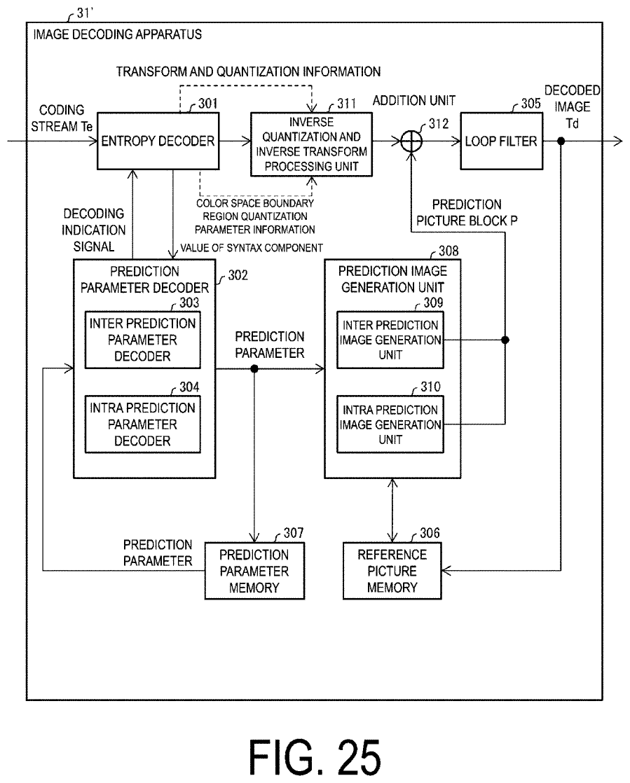

FIG. 25 is a block diagram illustrating a modification of the image decoding apparatus 31′ of FIG. 23. As illustrated in FIG. 25, in a case that reference is made to a source image signal, the entropy decoder 301 decodes boundary region information and color space boundary region quantization parameter information indicating whether a pixel value of a target block (coding unit (quantization unit)) is included in a boundary region in a color space. In addition, in a case that the target block is included in the boundary region with reference to the boundary region information, the inverse quantization and inverse transform processing unit 311 performs inverse quantization by using the quantization parameter (QP2) derived from the color space boundary region quantization parameter information. Otherwise, inverse quantization is performed by using the quantization parameter (QP1) for the pixel value included in the color space region.

### Specific Configuration of Color Space Boundary Region Quantization Parameter Information Generation Unit

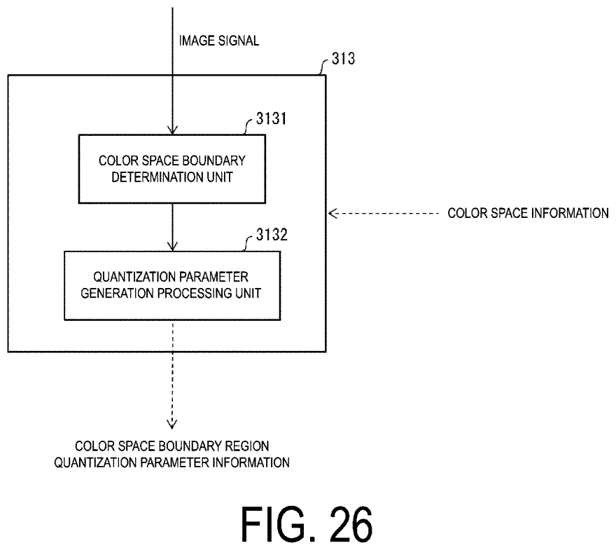

A specific configuration of the parameter generation unit 313 will be described below with reference to FIG. 26. FIG. 26 is a block diagram illustrating a specific configuration of the parameter generation unit 313. Note that the parameter generation unit 114 has the same configuration as the parameter generation unit 313, and the description of the parameter generation unit 114 will be omitted in the following description for the sake of simplicity.

A color space boundary determination unit 3131 determines whether a decoded image signal of a block neighboring on the target block generated by the addition unit 312 or a prediction image signal of the target block generated by the prediction image generation unit 308 (also including a source image of the target block in a case of the parameter generation unit 114) is included in a boundary region of a color space.

In a case that the color space boundary determination unit 3131 determines that the signal is included in the boundary region, a quantization parameter generation processing unit 3132 derives a quantization parameter (QP2) that is different from the quantization parameter (QP1) for pixel values included in the boundary region.

### Boundary Region

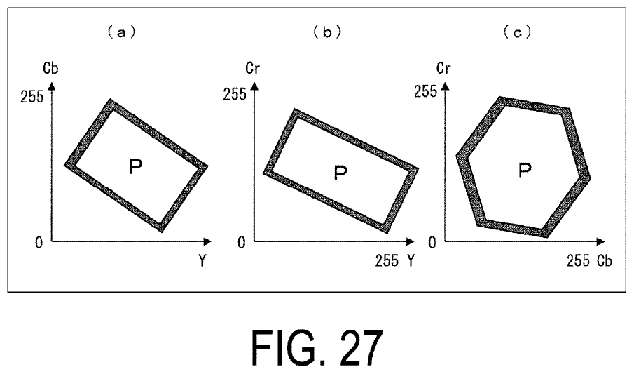

A boundary region of a color space determined by the color space boundary determination unit 3131 of the parameter generation unit 313 according to the present embodiment will be described below with reference to FIG. 27. (a) of FIG. 27 is a graph illustrating a color space with luminance Y and chrominance Cb in a case of an 8-bit graysc ale of pixels. (b) of FIG. 27 is a graph illustrating a color space with luminance Y and chrominance Cr in the case of an 8-bit grayscale of pixels. (c) of FIG. 27 is a graph illustrating a color space with chrominance Cb and chrominance Cr in the case of an 8-bit grayscale of pixels. The region indicated by P in (a) to (c) of FIG. 27 is a region that has a value in a case where an RGB space is transformed to a YCbCr space, and the shaded region around the region indicates a boundary region.

As illustrated in (a) to (c) of FIG. 27, the boundary region corresponds to a region near a maximum value or a minimum value of one component with a value of the other component being fixed. Thus, in a case that quantization or the like is performed on a pixel value in the boundary region, there is a problem in that the pixel value easily deviates from the region P, resulting in an error. Thus, the parameter generation unit 313 according to the present embodiment configures a quantization parameter for the pixel value included in the boundary region in the color space to a value different from a quantization parameter for a pixel value included in a region other than the boundary region. Although the example described above is an example of the 8-bit grayscale of pixels, the grayscale of pixels is not limited thereto, and a 10-bit, 11-bit, 12-bit, 14-bit, or 16-bit grayscale, or the like may be applied.

### Specific Example of Explicit Determination of Boundary Region

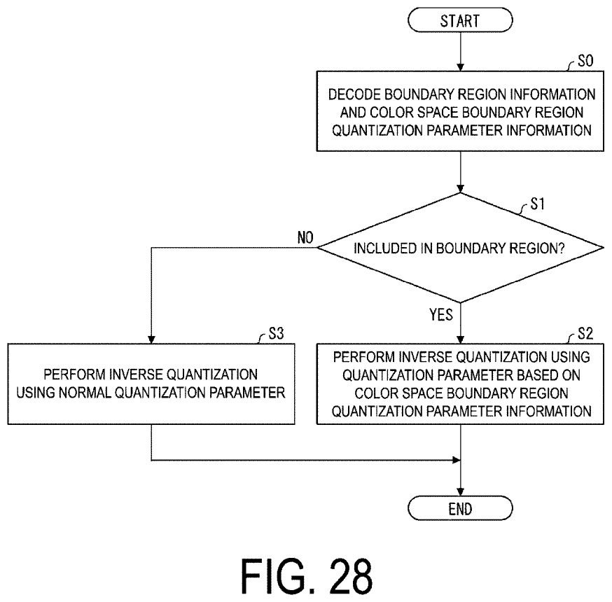

A specific example of an explicit determination method for a boundary region by the image decoding apparatus 31′ according to the present embodiment will be described below with reference to FIG. 28. FIG. 28 is a flowchart diagram illustrating a method for performing inverse quantization by the image decoding apparatus 31′ in a case that a source image is referred to, as illustrated in FIG. 6.

First, the entropy decoder 301 decodes boundary region information and color space boundary region quantization parameter information indicating whether a target block is included in a boundary region of the color space (step 50).

Next, the inverse quantization and inverse transform processing unit 311 determines whether the target block is included in the boundary region of the color space from the boundary region information decoded by the entropy decoder 301 (step S1). In a case that the boundary region information indicates that the target block is included in the boundary region of the color space (YES in step S1), the process proceeds to step S2, and in a case that the boundary region information does not indicate that the target block is included in the boundary region of the color space (NO in step S1), the process proceeds to step S3.

In step S2, the inverse quantization and inverse transform processing unit 311 uses (configures) a quantization parameter (QP2) derived using color space boundary region quantization parameter information on the target block to perform inverse quantization.

In step S3, the inverse quantization and inverse transform processing unit 311 uses (configures) a normal quantization parameter (QP1) on the target block to perform inverse quantization.

As described above, the video decoding apparatus (the image decoding apparatus 31′) according to the present specific example further includes the boundary region information decoder (the entropy decoder 301) that decodes boundary region information and color space boundary region quantization parameter information indicating whether a target block is included in a boundary region of a color space, and in a case that the boundary region information indicates that the target block is included in the boundary region of the color space, the configuration unit (the inverse quantization and inverse transform processing unit 311) configures a quantization parameter (QP2) derived using the color space boundary region quantization parameter information to perform inverse quantization.

According to the above-described configuration, it is possible to determine whether the target block is included in the boundary region based on the boundary region information decoded from coded data, and in a case that the target block is included in the boundary region, an appropriate quantization parameter is applied to perform inverse quantization with high accuracy, making it possible to prevent the pixel value from becoming an error (outside the color space region) and to reduce the possibility of being included in a range that does not exist in the source image. Thus, the degradation of image quality caused by the presence of a pixel value with an error in the color space can be prevented.

### Specific Example of Implicit Determination Method for Boundary Region

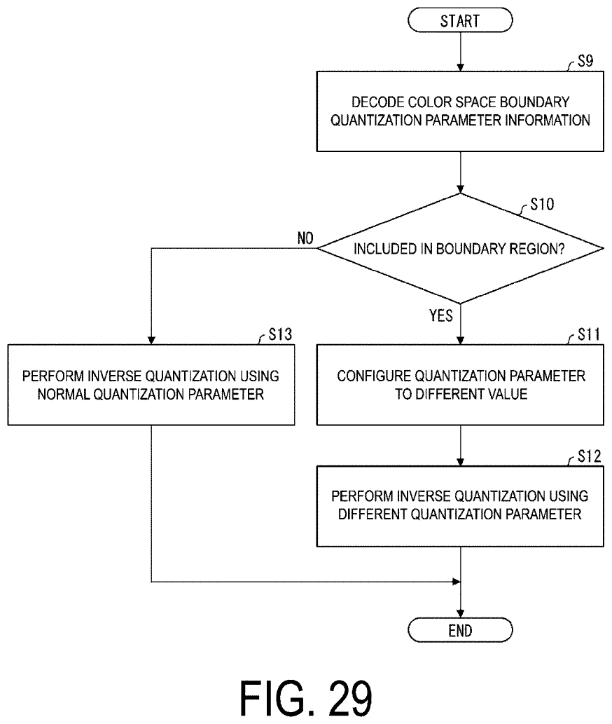

A specific example of an implicit determination method for a boundary region by the parameter generation unit 313 according to the present embodiment will be described below with reference to FIG. 29. FIG. 29 is a flowchart diagram illustrating the implicit determination method for a boundary region by the parameter generation unit 313 according to the present specific example. Note that, although the example described below will describe a case that causes a boundary region of pixel values of a target block in a color space to be determined using a decoded image signal, the same applies to a case that a prediction image signal is used.

First, the entropy decoder 301 decodes color space boundary region quantization parameter information (step S09).

Next, the color space boundary determination unit 3131 of the parameter generation unit 313 determines whether the target block is included in the boundary region of the color space from the decoded image signal of a block neighboring the target block generated by the addition unit 312 (step S10). In a case that the color space boundary determination unit 3131 determines that the target block is included in the boundary region of the color space, the process proceeds to step S11 (YES in step S10). In a case that the color space boundary determination unit 3131 determines that the target block is not included in the boundary region of the color space, the process proceeds to step S13 (NO in step S10).

In step S11, the quantization parameter generation processing unit 3132 of the parameter generation unit 313 uses color space boundary region quantization parameter information to derive a quantization parameter (QP2) of the boundary region determined by the color space boundary determination unit 3131.

Next, the inverse quantization and inverse transform processing unit 311 performs inverse quantization on the target block using the quantization parameter (QP2) configured by the parameter generation processing unit 3132 (step S12).

In addition, the inverse quantization and inverse transform processing unit 311 uses a normal quantization parameter (QP1) on target block to perform inverse quantization (step S13).

In a case that a prediction image signal is used, the prediction image of the target block is used in step 10 rather than the decoded image signal of the block neighboring the target block.

As described above, the video decoding apparatus (the image decoding apparatus 31′) according to the present specific example further includes a determination unit (the color space boundary determination unit 3131) that determines whether the target block is included in the boundary region of the color space, and the configuration unit (the quantization parameter generation processing unit 3132) configures, in a case that the determination unit determines that the target block is included in the boundary region of the color space, a quantization parameter of a block included in the boundary region to a value different from a quantization parameter for a block included in a region other than the boundary region.

According to the above-described configuration, by applying an appropriate quantization parameter to a pixel value included in a determined boundary region to perform inverse quantization with high accuracy, it is possible to prevent the pixel value from having an error and to reduce the possibility of being included in a range that does not exist in a source image. Thus, degradation of image quality caused by the presence of a pixel value with an error in the color space can be prevented.

More specifically, in step S10 described above, the color space boundary determination unit 3131 may refer to a decoded quantization unit (generated by the addition unit 312) around a target quantization unit (for example, CTU or CU) to determine whether the quantization unit is included in the boundary region of the color space.

According to the above-described configuration, the boundary region can be determined by referring to the decoded quantization unit around the target quantization unit, and by applying an appropriate quantization parameter to the boundary region to perform inverse quantization with high accuracy, it is possible to prevent the pixel value from having an error and to reduce the possibility of being included in a range that does not exist in a source image. Thus, the degradation of image quality caused by the presence of a pixel value with an error in the color space can be prevented.

Further, in another example, in step S10 described above, the color space boundary determination unit 3131 may determine whether the prediction image of the quantization unit generated by the prediction image generation unit 308 is included in the boundary region of the color space.

According to the above-described configuration, by applying an appropriate quantization parameter to the quantization unit of the boundary region of the color space of the prediction image to perform inverse quantization with high accuracy, it is possible to prevent the pixel value from having an error and to reduce the possibility of being included in a range that does not exist in the source image. Thus, degradation of image quality caused by the presence of a pixel value with an error in the color space of the prediction image can be prevented.

In addition, in another example, in the above-described step S10, the color space boundary determination unit 3131 may first code and decode a luminance signal of a pixel value out of the pixel values of the target block and then determine whether the chrominance signal is included in the boundary region of the color space from a decoded image signal of the luminance signal and a decoded image signal of a neighboring block or the chrominance signal of the prediction image of the block.

According to the above-described configuration, it is possible to determine whether the chrominance signal is included in a boundary region of the color space by using the coded and decoded luminance signal of the block. Then, by applying an appropriate quantization parameter to the chrominance signal included in the determined boundary region to perform inverse quantization with high accuracy, it is possible to prevent the pixel value from having an error and to reduce the possibility of being included in a range that does not exist in the source image. Thus, the degradation of image quality caused by the presence of a pixel value with an error in the color space can be prevented.

### Specific Configuration of Color Space Boundary Determination Unit

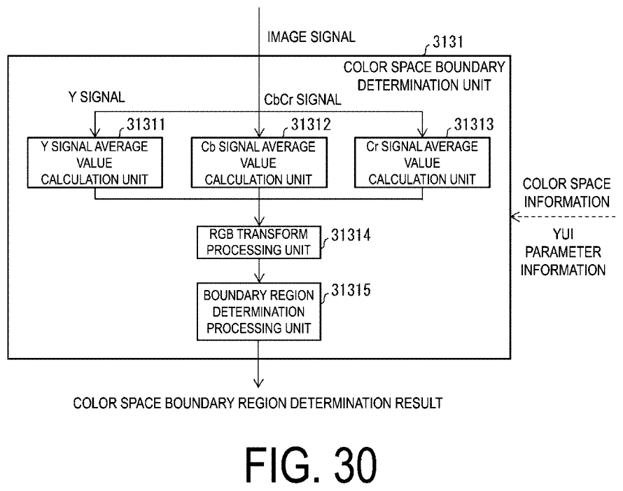

A specific configuration of the color space boundary determination unit 3131 will be described below with reference to FIG. 30. FIG. 30 is a block diagram illustrating a specific configuration of the color space boundary determination unit 3131. As illustrated in FIG. 30, the color space boundary determination unit 3131 includes a Y signal average value calculation unit 31311, a Cb signal average value calculation unit 31312, a Cr signal average value calculation unit 31313, an RGB transform processing unit 31314, and a boundary region determination processing unit 31315.

The Y signal average value calculation unit 31311 calculates the average value of Y signals of a decoded image of a neighboring block generated by the addition unit 312.

The Cb signal average value calculation unit 31312 calculates the average value of Cb signals of the decoded image of the neighboring block generated by the addition unit 312.

The Cr signal average value calculation unit 31313 calculates the average value of Cr signals of the decoded image of the neighboring block generated by the addition unit 312.

The RGB transform processing unit 31314 transforms the average value of the Y signals calculated by the Y signal average value calculation unit 31311, the average value of the Cb signals calculated by the Cb signal average value calculation unit 31312, and the average value of the Cr signals calculated by the Cr signal average value calculation unit 31313 into values of RGB signal.

The boundary region determination processing unit 31315 determines whether the target block inferred from the decoded image of the neighboring block is included in the boundary region in the RGB color space based on the respective magnitude relationship between the values of R, G, and B signals transformed by the RGB transform processing unit 31314 and thresholds of the R, G, and B signals.

In the above-described example, the color space boundary determination process may be performed using the prediction image of the target block generated by the prediction image generation unit 308, instead of the decoded image of the neighboring block.

Note that although the average values in the target block are used in the present embodiment, median values and modes with statistically similar properties may be used.

### Specific Example of Implicit Determination Method for Boundary Region (2)

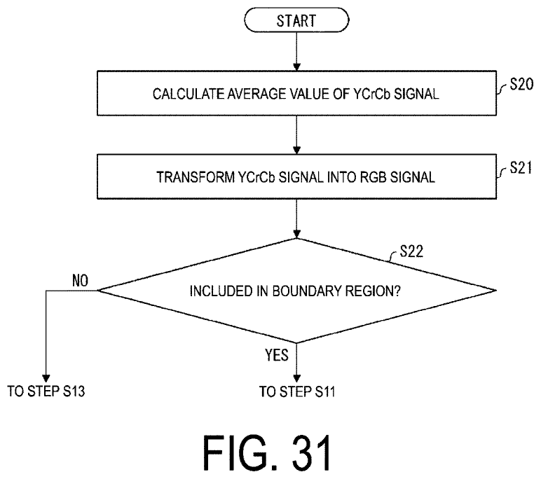

A second specific example of the implicit determination method for the boundary region by the color space boundary determination unit 3131 according to the present embodiment will be described below with reference to FIG. 31. FIG. 31 is a flowchart diagram illustrating an implicit determination method for the boundary region by the color space boundary determination unit 3131 according to the present specific example. Note that, although the example described below will describe a case that causes the boundary region of the decoded image of the neighboring block in the RGB color space to be determined, the same applies to a prediction image of a target block.

First, the Y signal average value calculation unit 31311, the Cb signal average value calculation unit 31312, and the Cr signal average value calculation unit 31313 respectively calculate the average value of the Y, Cr, and Cb signals of the decoded image of the neighboring block generated by the addition unit 312 (step S20).

Next, the RGB transform processing unit 31314 transforms the average value of the Y signals calculated by the Y signal average value calculation unit 31311, the average value of the Cb signals calculated by the Cb signal average value calculation unit 31312, and the average value of the Cr signals calculated by the Cr signal average value calculation unit 31313 into RGB signals (step S21).

Next, the boundary region determination processing unit 31315 determines whether the target block inferred from the decoded image of the neighboring block is included in the boundary region of the RGB color space based on the respective magnitude relationship between the values of R, G, and B signals transformed by the RGB transform processing unit 31314 and the thresholds of the R, G, and B signals (step S22). In a case that the boundary region determination processing unit 31315 determines that the target block is included in the boundary region of the color space, the process proceeds to step S11 described above (YES in step S22). In a case that the boundary region determination processing unit 31315 determines that the target block is not included in the boundary region of the color space, the process proceeds to step S13 (NO in step S22).

In the above-described example, the color space boundary determination process may be performed using the prediction image of the target block generated by the prediction image generation unit 308, instead of the decoded image of the neighboring block.

### Specific Configuration of Color Space Boundary Determination Unit (2)

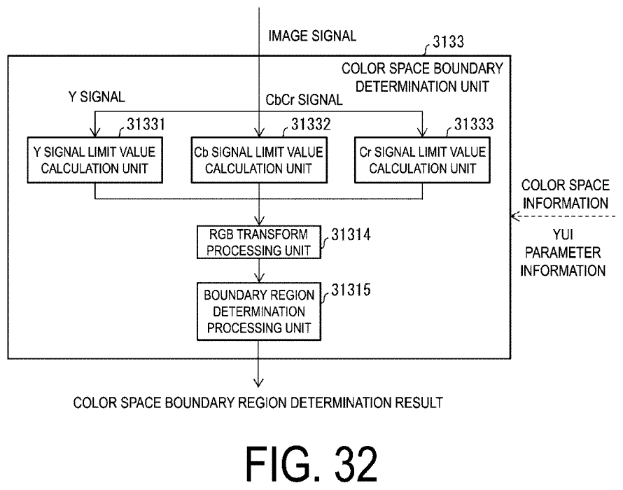

Hereinafter, a configuration of a color space boundary determination unit 3133 according to another aspect of the color space boundary determination unit 3131 will be described with reference to FIG. 32. FIG. 32 is a block diagram illustrating a specific configuration of the color space boundary determination unit 3133. As illustrated in FIG. 32, the color space boundary determination unit 3133 includes a Y signal limit value calculation unit 31331, a Cb signal limit value calculation unit 31332, and a Cr signal limit value calculation unit 31333, instead of the Y signal average value calculation unit 31311, the Cb signal average value calculation unit 31312, and the Cr signal average value calculation unit 31313 in the configuration of the color space boundary determination unit 3131 described above. Note that, members having similar functions to those of the members included in above-described the color space boundary determination unit 3131 will denoted by the same reference signs, and description thereof will not be repeated.

The Y signal limit value calculation unit 31331 calculates a maximum value and a minimum value of Y signals of a decoded image of a neighboring block generated by the addition unit 312.

The Cb signal limit value calculation unit 31332 calculates a maximum value and a minimum value of Cb signals of the decoded image of the neighboring block generated by the addition unit 312.

The Cr signal limit value calculation unit 31333 calculates a maximum value and a minimum value of Cr signals of the decoded image of the neighboring block generated by the addition unit 312.

According to the above description, whether the target block inferred from the decoded image of the neighboring block is included in the boundary region of the RGB color space is determined.

### Specific Example of Implicit Determination Method for Boundary Region (3)

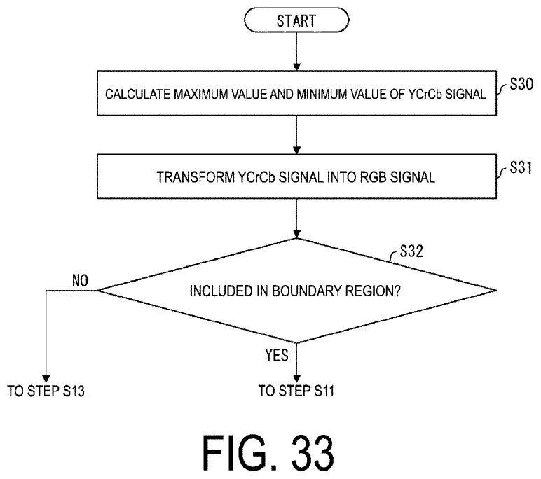

A third specific example of the implicit determination method for the boundary region by the color space boundary determination unit 3133 according to the present embodiment will be described below with reference to FIG. 33. FIG. 33 is a flowchart diagram illustrating an implicit determination method for the boundary region by the color space boundary determination unit 3133 according to the present specific example. Note that, although the example described below will describe a case in which the boundary region of the color space of the decoded image of the neighboring block is determined, the same applies to a prediction image of a target block.

First, the Y signal limit value calculation unit 31331, the Cb signal limit value calculation unit 31332, and the Cr signal limit value calculation unit 31333 respectively calculate a maximum value and a minimum value of the Y, Cr, and Cb signals of the decoded image of the neighboring block generated by the addition unit 312 (step S30).

Next, the RGB transform processing unit 31314 transforms the maximum value and the minimum value of the Y signals calculated by the Y signal limit value calculation unit 31331, the maximum value and the minimum value of the Cb signals calculated by the Cb signal limit value calculation unit 31332, and the maximum value and the minimum value of the Cr signals calculated by the Cr signal limit value calculation unit 31333 into RGB signals (step S31).

Next, the boundary region determination processing unit 31315 determines whether the target block inferred from the decoded image of the neighboring block is included in the boundary region of the RGB color space based on the respective magnitude relationship between the values of R, G, and B signals transformed by the RGB transform processing unit 31314 and the thresholds of the R, G, and B signals (step S32). In a case that the boundary region determination processing unit 31315 determines that the target block is included in the boundary region of the color space, the process proceeds to step S11 described above (YES in step S32). In a case that the boundary region determination processing unit 31315 determines that the target block is not included in the boundary region of the color space, the process proceeds to step S13 (NO in step S32).

In the above-described example, the color space boundary determination process may be performed using the prediction image of the target block generated by the prediction image generation unit 308, instead of the decoded image of the neighboring block.

Here, the boundary region determination processing unit 31315 determines whether the target block is included in the boundary region of the color space. With the assumption that a bit length of each of the input R signal, G signal, and B signal is a BitDepth bit, the minimum value is 0, and the maximum value is ((1<<BitDepth)−1). In step S32 described above, the boundary region determination processing unit 31315 configures a threshold Th and determines that the target block is included in the boundary region of the RGB color space in a case that the difference between the input RGB signal and the maximum value of the RGB signal ((1<<BitDepth)−1) is less than the threshold, or the RGB signal is less than the threshold Th. A formula for the determination is indicated below.

if (R < Th ∥ ((1 << BitDepth) − 1) − R < Th ∥ G < Th ∥ ((1 << BitDepth) − 1) − G < Th ∥ B
< Th ∥ ((1 << BitDepth) − 1) − B < Th) {

/* Color space boundary region*/

} else {

/* Other region*/

}

The R signal, G signal, and B signal in the above-described formula are values respectively obtained from the average values of the Y signal, Cb signal, and Cr signal of the block in the case of the embodiment of FIG. 31. In the case of the embodiment of FIG. 33, the following determination formula may be used using Rmax, Gmax, and Bmax respectively obtained from the maximum values and Rmin, Gmin, and Bmin respectively obtained from the minimum values of the Y signal, Cb signal, and Cr signal of the block.

if (R min<Th∥((1<<BitDepth)−1)−R max<Th∥G min<Th∥((1<<BitDepth)−1)−

Gmax < Th ∥ Bmin < Th ∥ ((1 << BitDepth) − 1) − Bmax < Th) {

/* Color space boundary region*/

} else {

/* Other region*/

}

In another example, without performing the above-described step S31, the boundary region determination processing unit 31315 determines, in the above-described step S32, whether the target block inferred from the decoded image of the neighboring block is included in the boundary region based on the respective magnitude relationships between the average values, or the maximum values and the minimum values, of the Y signal, Cb signal, and Cr signal of the decoded image of the neighboring block and the maximum values and the minimum values of the Y signal, Cb signal, and Cr signal specified in the color space standard. For example, in BT.709, with the assumption that the pixel bit length of the Y signal is BitDepthY bit, the minimum value of the Y signal is (16<<(BitDepthY−8)), and the maximum is (235<<(BitDepthY)), and with the assumption that the pixel bit length of each of the Cb signal and the Cr signal is BitDepthC bit, the minimum value and the maximum value of each of the Cb signal and Cr signal are (16<<(BitDepthC−8)) and (240<<(BitDepthC)) respectively. More specifically, in the above-described step S32, the boundary region determination processing unit 31315 configures a threshold Th of a value near each minimum value (Ymin, Cbmin, Crmax) or each maximum value (Ymax, Cbmax, Crmax) of the Y signal, Cb signal, and Cr signal or, and in a case that each of the differences between the average value or the minimum value (Y, Cb, Cr) of the decoded image of the neighboring block and (Ymin, Cbmin, and Crmin) is less than the threshold, or in a case that each of the differences between (Ymax, Cbmax, Crmax) and the maximum value of the decoded image of the neighboring block (Y, Cb, Cr) is less than the threshold Th, the target block is determined to be included in the boundary region. A formula for the determination is indicated below.

if (Y − Ymin < Th ∥ Ymax − Y < Th ∥ Cb − Cbmin < Th ∥Cbmax − Cb < Th ∥ Cr − Crmin <
Th ∥Crmax − Cr < Th) {

/* Color space boundary region*/

} else {

/* Other Region*/

}

As described above, the boundary region determination processing unit 31315 determines whether the target block inferred from the decoded image of the neighboring block is included in the boundary region of the RGB color space.

Note that, in the above-described example, the color space boundary determination process may be performed using a prediction image of the target block generated by the prediction image generation unit 308, instead of the decoded image of the neighboring block.

As described above, the video decoding apparatus (the image decoding apparatus 31′) that performs the implicit determination method of the above-described specific example (2) or (3) further includes a transform processing unit (the RGB transform processing unit 31314) that transforms the decoded image of the neighboring block or the prediction image of the target block defined in the color space into another color space, and the determination unit (the boundary region determination processing unit 31315) determines whether the pixel value transformed by the transform processing unit is included in the boundary region of the other color space.

According to the above-described configuration, it is possible to determine whether the target block is included in the boundary region with reference to the range in which the source image that has been transformed and defined by the other color space exists. In a case that the target block is included in the boundary region, by applying an appropriate quantization parameter to perform inverse quantization with high accuracy, it is possible to prevent the target block from having an error and to reduce the possibility of being included in a range that does not exist in the source image. Thus, the degradation of image quality caused by the presence of a pixel value with an error in the other color space can be prevented.

In addition, the video decoding apparatus (the image decoding apparatus 31′) that performs the implicit determination method of the above-described specific example (2) or (3) further includes a calculation unit (the Y signal average value calculation unit 31311, the Cb signal average value calculation unit 31312, and the Cr signal average value calculation unit 31313, or the Y signal limit value calculation unit 31331, the Cb signal limit value calculation unit 31332, and the Cr signal limit value calculation unit 31333) that calculates a maximum value, a minimum value, or an average value of a pixel value of a decoded image of a neighboring block or a prediction image of a target block, and the determination unit (the boundary region determination processing unit 31315) determines whether the target block is included in the boundary region of the color space by determining whether the maximum value, the minimum value, or the average value is greater than the threshold.

According to the above configuration, the boundary region can be determined based on the threshold in accordance with the calculated maximum value, minimum value, or average value. In a case that these values are included in the boundary region, by applying an appropriate quantization parameter to perform inverse quantization with high accuracy, it is possible to prevent the pixel value from having an error and to reduce the possibility of being included in a range that does not exist in the source image. Thus, the degradation of image quality caused by the presence of a pixel value with an error in the color space can be prevented.

### Modification of Implicit Determination Method for Boundary Region (1)

Hereinafter, a modification of the implicit determination method for the boundary region by the color space boundary determination unit 3131 or the color space boundary determination unit 3133 according to the present embodiment will be described.

For example, without performing step S31 described above, the boundary region determination processing unit 31315 may determine whether a pixel value of the target block is a pixel value included in the boundary region of the color space for each of the components of the Y signal, the Cb signal, and the Cr signal in step S32 described above, A formula for the configuration is indicated below.

//Determination of Y
if (Y − Ymin < Th ∥ Ymax − Y < Th) {

/* Color space boundary region*/

} else {

/* Other region*/

}
//Determination of Cb
if (Cb − Cbmin < Th ∥ Cbmax − Cb < Th) {

/* Color space boundary region*/

} else {

/* Other region*/

}
//Determination of Cr
if (Cr − Crmin < Th ∥ Crmax − Y < Th) {

/* Color space boundary region*/

} else {

/* Other region*/

}

As indicated by the above formula, for example, for the Y signal, the boundary region determination processing unit 31315 determines that the pixel value indicated by the Y signal is a pixel value included in the boundary region of the YCbCr color space in a case that the value obtained by subtracting the minimum value of the Y signal from the value indicated by the Y signal is less than a threshold or the difference value between the value indicated by the Y signal and the maximum value of the Y signal is less than a threshold.

In addition, meanwhile, for the Cb signal, the boundary region determination processing unit 31315 determines that the pixel value of the Cb signal is a pixel value included in the boundary region of the YCbCr color space in a case that the value obtained by subtracting the minimum value of the Cb signal from the value indicated by the Cb signal is less than a threshold or the difference value between the value indicated by the Cb signal and the maximum value of the Cb signal is less than a threshold.

In addition, meanwhile, for the Cr signal, the boundary region determination processing unit 31315 determines that the pixel value of the Cr signal is a pixel value included in the boundary region of the YCbCr color space in a case that the value obtained by subtracting the minimum value of the Cr signal from the value indicated by the Cr signal is less than the threshold or the difference value between the value indicated by the Cr signal and the maximum value of the Cr signal is less than a threshold.

As described above, with respect to the video decoding apparatus (the image decoding apparatus 31′) according to the present modification, a pixel value of a target block includes components of a luminance, a first chrominance (e.g., Cb), and a second chrominance (e.g., Cr), and the determination unit (the boundary region determination processing unit 31315) determines whether the pixel value of the target block is a pixel value included in the boundary region of the color space for each of the above-described components.

According to the above-described configuration, the boundary region can be determined for each component. Then, by applying an appropriate quantization parameter to each of the components of the pixel value included in the boundary region to perform inverse quantization with high accuracy, it is possible to prevent each component of the pixel value from having an error and to reduce the possibility of being included in a range that does not exist in the source image. Thus, the degradation of image quality caused by the presence of a pixel value with an error in the color space can be prevented.

### Modification of Implicit Determination Method for Boundary Region (2)

Hereinafter, another modification of the implicit determination method for the boundary region by the color space boundary determination unit 3131 or the color space boundary determination unit 3133 according to the present embodiment will be described.

For example, in step S32 described above, the boundary region determination processing unit 31315 may determine whether the pixel value of the target block is a pixel value included in a boundary region of a color space for each of the components of the R signal, the G signal, and the B signal transformed by the RGB transform processing unit 31314. A formula for the configuration is indicated below.

//Determination of R
if (R < Th ∥ ((1 << BitDepth) − 1) − R < Th) {

/* Color space boundary region*/

} else {

/* Other region*/

}
//Determination of G
if (G < Th ∥ ((1 << BitDepth) − 1) − G < Th) {

/* Color space boundary region*/

} else {

/* Other region*/

}
//Determination of B
if (B < Th ∥ ((1 << BitDepth) − 1) − B < Th) {

/* Color space boundary region */

} else {

/* Other region */

}

As indicated by the above formula, for example, for the R signal, the boundary region determination processing unit 31315 determines that the pixel value of the R signal is a pixel value included in the boundary region of the RGB color space in a case that the value indicated by the R signal is less than the threshold Th or the value obtained by subtracting the value indicated by the R signal from the maximum value of the R signal ((1<<BitDepth)−1)) is less than the threshold.

In addition, meanwhile, for the G signal, the boundary region determination processing unit 31315 determines that the pixel value of the G signal is a pixel value included in the boundary region of the RGB color space in a case that the value indicated by the G signal is less than the threshold Th or the value obtained by subtracting the value indicated by the G signal from the maximum value of the G signal ((1<<BitDepth)−1)) is less than the threshold.

In addition, meanwhile, for the B signal, the boundary region determination processing unit 31315 determines that the pixel value of the B signal is a pixel value included in the boundary region of the RGB color space in a case that the value indicated by the B signal is less than the threshold Th or the value obtained by subtracting the value indicated by the B signal from the maximum value of the B signal ((1<<BitDepth)−1)) is less than the threshold.

As described above, the video decoding apparatus (the image decoding apparatus 31′) according to the present modification further includes the transform processing unit (the RGB transform processing unit 31314) that transforms the pixel value of the target block defined by the color space into a pixel value of a target block defined by another color space. The pixel value transformed by the transform processing unit includes components of a first pixel value (e.g., R), a second pixel value (e.g., G), and a third pixel value (e.g., B), and the determination unit (the boundary region determination processing unit 31315) determines, for each of the above-described components, whether the pixel value of the target block is a pixel value included in the boundary region of the other color space.

According to the above-described configuration, the boundary region can be determined for each component of the transformed pixel value. Then, by applying an appropriate quantization parameter to each of the components of the pixel value included in the boundary region to perform inverse quantization with high accuracy, it is possible to prevent each component of the pixel value from having an error and to reduce the possibility of being included in a range that does not exist in the source image. Thus, the degradation of image quality caused by the presence of a pixel value with an error in the color space can be prevented.

Transform from YCbCr Signal into RGB Signal

An example formula for transforming the YCbCr signal into the RGB signal by the RGB transform processing unit 31314 in step S21 or step S31 described above is described below.

R=(255.0*BitDepth)/(219*BitDepthY)*(Y−(16<<(BitDepthY−8)))+((255.0*BitDepth)/(112*BitDepthC)*(1.0−Kr))*(Cr−(1<<(BitDepthC−1)))

G=(255.0*BitDepth)/(219*BitDepthY)*(Y−(16<<(BitDepthY−8))−((255.0*BitDepth)/(112*BitDepthC)*Kb*(1.0−Kb)/Kg)*(Cb−(1<<(BitDepthC−1)))−((255.0*BitDepth)/(112*BitDepthC)*Kr*(1.0−Kr)/Kg)*(Cr−(1<<(BitDepthC−1)))B=(255.0*BitDepth)/(219*BitDepthY)*(Y−(16<<(BitDepthY−8)))+((255.0*BitDepth)/(112*BitDepthC)*(1.0−Kb))*(Cb−(1<<(BitDepthC−1)))

In a case of BT.709,
Kr=0.2126, Kg=0.7152, and Kb=0.0722.

In a case of BT.2020
Kr=0.2627, Kg=0.6780, and Kb=0.0593. In addition, BitDepthY is a pixel bit length of the luminance signal Y, and BitDepthC is a pixel bit length of the chrominance signals Cb and Cr. BitDepth is a pixel bit length of the RGB signal.

### Specific Example of Quantization Parameter Configuration Method (1)

A specific example of a quantization parameter configuration method by the quantization parameter generation processing unit 3132 according to the present embodiment will be described below. As described above, the quantization parameter generation processing unit 3132 configures a quantization parameter for a block included in a boundary region determined by the color space boundary determination unit 3131 to a value different from a quantization parameter for a block included in a region other than the boundary region.

For example, in step S11 described above, the quantization parameter generation processing unit 3132 configures the quantization parameter Q2 for the block included in the boundary region determined by the color space boundary determination unit 3131 to a value less than the quantization parameter Q1 for the block included in the region other than the boundary region. This allows, in the above-described step S12, the inverse quantization and inverse transform processing unit 311 to perform inverse quantization on the block included in the boundary region using the quantization parameter Q2 configured by the quantization parameter generation processing unit 3132 and perform fine inverse quantization, thus causing a quantization error to be smaller.

More specifically, before step S11 described above, the entropy decoder 301 decodes an offset value qpOffset2. Next, in step S12, the quantization parameter generation processing unit 3132 configures the quantization parameter Q2 for the block included in the boundary region determined by the color space boundary determination unit 3131 to a value obtained by subtracting the offset value qpOffset2 from the quantization parameter Q1 for the block included in the region other than the boundary region. A formula for the quantization parameter Q1 (qP) for the block included in the region other than the boundary region in the example and a formula for the quantization parameter Q2 (QPc) for the block included in the boundary region are indicated below.

qP=qP

QPc=qP−qpOffset2

As described above, the video decoding apparatus (the image decoding apparatus 31′) according to the present specific example further includes the offset value decoder (the entropy decoder 301) that decodes an offset value. The configuration unit (the quantization parameter generation processing unit 3132) calculates the quantization parameter for the block included in the boundary region of the color space by subtracting the offset value from the quantization parameter for the block included in the region other than the boundary region.

According to the above-described configuration, it is possible to perform the inverse quantization with high accuracy by applying the quantization parameter from which the offset value has been subtracted to the block included in the boundary region. Thus, it is possible to prevent the pixel value from having an error and to reduce the possibility of being included in a range that does not exist in the source image. Thus, the degradation of image quality caused by the presence of a pixel value with an error in the color space can be prevented.

### Specific Example of Quantization Parameter Configuration Method (2)

A second specific example of the quantization parameter configuration method by the quantization parameter generation processing unit 3132 according to the present embodiment will be described below.

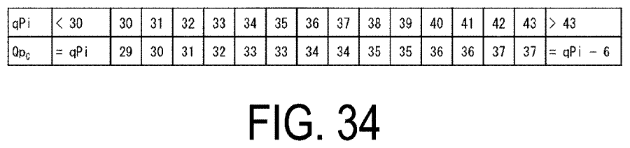

For example, in step S11 described above, the quantization parameter generation processing unit 3132 configures the quantization parameter Q2 for the block included in the boundary region of the color space with reference to a table in which the quantization parameter Q1 for the block included in the region other than the boundary region is associated with the quantization parameter Q2 for the block included in the boundary region of the color space. FIG. 34 illustrates the table. In FIG. 34, qPi indicates the quantization parameter Q1 for the block included in the region other than the boundary region, and Qpc indicates the quantization parameter Q2 for the block included in the boundary region of the color space.

More specifically, with reference to FIG. 34, in a case that the quantization parameter qPi for the block included in the region other than the boundary region is less than 30, the quantization parameter generation processing unit 3132 references the table illustrated in FIG. 34 to configure the quantization parameter Qpc for the block included in the boundary region of the color space to the same value as qPi.

In addition, in a case that the quantization parameter qPi for the block included in the region other than the boundary region is 30, for example, the quantization parameter generation processing unit 3132 references the table illustrated in FIG. 34 to configure the quantization parameter Qpc for the block included in the boundary region of the color space to 29.

In addition, in a case that the quantization parameter qPi for the block included in the region other than the boundary region is 39, for example, the quantization parameter generation processing unit 3132 references the table illustrated in FIG. 34 to configure the quantization parameter Qpc for the block included in the boundary region of the color space to 35.

In addition, in a case that the quantization parameter qPi for the block included in the region other than the boundary region is 43, for example, the quantization parameter generation processing unit 3132 references the table illustrated in FIG. 34 to configure the quantization parameter Qpc for the block included in the boundary region of the color space to qPi-6.

As described above, in the video decoding apparatus (the image decoding apparatus 31′) according to the present specific example, the configuration unit (the quantization parameter generation processing unit 3132) configures a quantization parameter for the block included in the boundary region of the color space with reference to the table in which the quantization parameter for the block included in the region other than the boundary region is associated with the quantization parameter for the block included in the boundary region of the color space.

According to the above-described configuration, an appropriate quantization parameter can be configured with reference to the table in which the quantization parameter for the block included in the region other than the boundary region is associated with the quantization parameter for the block included in the boundary region of the color space. Thus, it is possible to perform the inverse quantization with high accuracy by applying the quantization parameter to the block included in the boundary region. Thus, it is possible to prevent the pixel value from having an error and to reduce the possibility of being included in a range that does not exist in the source image. Thus, the degradation of image quality caused by the presence of a pixel value with an error in the color space can be prevented.

### Specific Example of Quantization Parameter Configuration Method (3)

A third specific example of the quantization parameter configuration method by the quantization parameter generation processing unit 3132 according to the present embodiment will be described below. For example, in step S11 described above, the quantization parameter generation processing unit 3132 configures the quantization parameter QP2 for the block included in the boundary region of the color space to a value less than or equal to a predetermined threshold different from the quantization parameter QP1 for the block included in the region other than the boundary region.

More specifically, for example, in step S11 described above, the quantization parameter generation processing unit 3132 configures an upper limit qpMax for the quantization parameter QP2 for the block included in the boundary region of the color space, and clips the upper limit qpMax to qpMax. The relationship between the quantization parameter QP2 (qp) and the quantization parameter QP1 (qP) in this configuration is described below.

qp=min(qP,qp Max)

As indicated in the above formula, the quantization parameter generation processing unit 3132 configures the quantization parameter qp for the block included in the boundary region of the color space to a smaller value between qP (the quantization parameter QP1 for a block not included in the boundary region) and qpMax (the predetermined threshold), and thereby configures the quantization parameter qp to a value less than or equal to a predetermined threshold.

According to the above-described configuration, it is possible to prevent a quantization parameter from being a value greater than the predetermined threshold and to perform inverse quantization with high accuracy by applying a quantization parameter that is less than or equal to the predetermined threshold to the block included in the boundary region. Thus, it is possible to prevent the pixel value from having an error and to reduce the possibility of being included in a range that does not exist in the source image. Thus, degradation of image quality caused by the presence of a pixel value with an error in the color space can be curbed.

### Supplements of Quantization Parameter Configuration Method

Supplements for the specific examples of the quantization parameter configuration method by the quantization parameter generation processing unit 3132 according to the present embodiment will be described below. For example, in step S11 described above, the quantization parameter generation processing unit 3132 preferably performs the above-described steps only for a relatively large quantization unit. In other words, the quantization parameter generation processing unit 3132 preferably configures the quantization parameter QP2 for a block that is a target block of the relatively large quantization unit (coding unit) and included in a boundary region of a color space to a value different from the quantization parameter QP1 for a block included in a region other than the boundary region. Examples of the relatively large quantization unit include a CTU and the like.

The reason why the above described configuration is preferable is that distortion of color components during display is perceived by a user in a case that a display target is displayed with a pixel value of a large coding unit used for the display target having a relatively slow motion. On the other hand, in a case that a display target is displayed with a pixel value of a small coding unit used for the display target having a change in shape or a large motion, the user perceives a small degree of the distortion.

Further, with respect to another supplement, in step S11 described above, the quantization parameter generation processing unit 3132 may perform the above-described steps only for a specific component of the pixel value (for example, Y, Cb, or Cr). That is, the quantization parameter generation processing unit 3132 may configure, among a plurality of the specific component of a target block, a quantization parameter QPC2 for the specific component included in a boundary region of a color space to a value different from a quantization parameter QPC1 for components included in a region other than the boundary region.

According to the above-described configuration, by applying an appropriate quantization parameter to a specific pixel of a block included in the boundary region to perform inverse quantization with high accuracy, it is possible to prevent the component from having an error and to reduce the possibility of being included in a range that does not exist in the source image. Thus, the degradation of image quality caused by the presence of a component with an error in the color space can be prevented.

Note that, although coding and control of image quality of the decoded image are performed by controlling the quantization parameters in the present embodiment, similar effects can be obtained by controlling another parameter, for example, a lambda value itself which is a parameter for optimal mode selection or balance between a lambda value of a luminance signal and a lambda value of a chrominance signal.

### Syntax and Semantics

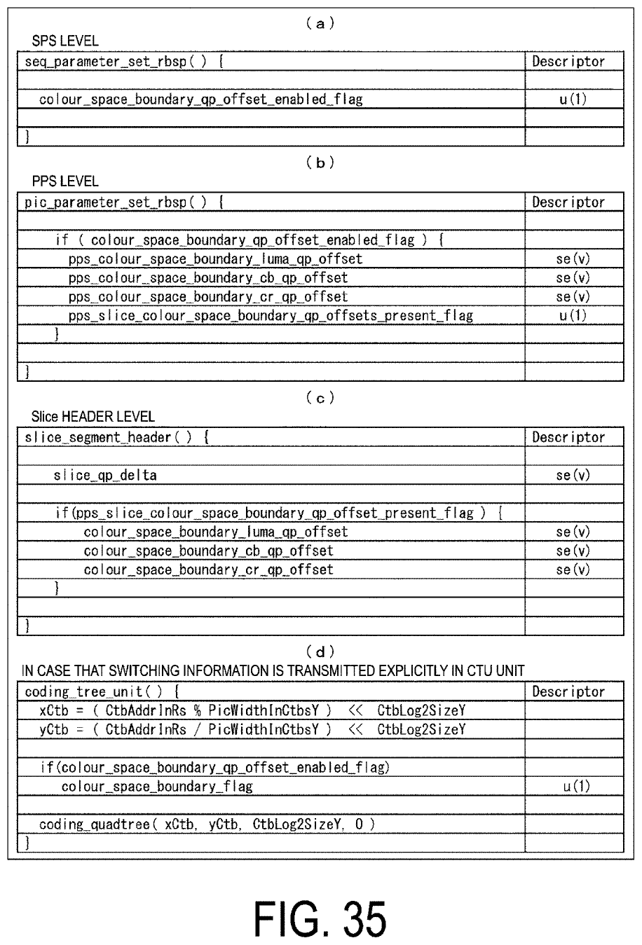

Hereinafter, syntax used by the parameter generation unit 313 and the parameter generation unit 114 according to the present embodiment in the above-described boundary region determination method and quantization parameter configuration method and semantics for the syntax will be described with reference to FIG. 35. (a) to (d) of FIG. 35 each are a syntax table indicating syntax used by the parameter generation unit 313 and the parameter generation unit 114 according to the present embodiment in the above-described boundary region determination method and quantization parameter configuration method.

As illustrated in (a) of FIG. 35, the entropy coder 104 of the image coding apparatus 11′ encodes a flag colour_space_boundary_qp_offset_enabled_flag in the sequence parameter set SPS. Meanwhile, the entropy decoder 301 of the image decoding apparatus 31′ decodes a flag colour_space_boundary_qp_offset_enabled_flag included in the sequence parameter set SPS. The flag colour_space_boundary_qp_offset_enabled_flag is a flag indicating whether an offset is to be applied to a quantization parameter for a block included in a boundary region of a color space in the sequence.

More specifically, before step S10 described above, the entropy decoder 301 decodes the flag colour_space_boundary_qp_offset_enabled_flag, and the parameter generation unit 313 determines whether the flag colour_space_boundary_qp_offset_enabled_flag indicates that an offset is to be applied to the quantization parameter for the block included in the boundary region of the color space (indicates that the offset is to be applied in a case that the flag is 1, and that the offset is not to be applied in a case that the flag is 0). In the case that the flag indicates that the offset is to be applied, the parameter generation unit 313 performs each step from step S10 described above.

Next, the syntax illustrated in (b) of FIG. 35 will be described. As illustrated in (b) of FIG. 35, the entropy coder 104 of the image coding apparatus 11′ determine whether the flag colour_space_boundary_qp_offset_enabled_flag indicates that an offset is to be applied to a quantization parameter for a block included in the boundary region of the color space. Then, in a case that the flag colour_space_boundary_qp_offset_enabled_flag indicates that an offset is to be applied to the quantization parameter for the block included in the boundary region of the color space, the entropy coder 104 codes each of the following flags in a picture parameter set PPS.
pps_colour_space_boundary_luma_qp_offset
pps_colour_space_boundary_cb_qp_offset
pps_colour_space_boundary_cr_qp_offset
pps_slice_colour_space_boundary_qp_offsets_present_flag

Meanwhile, the entropy decoder 301 of the image decoding apparatus 31′ decodes each of the above-described flags included in the picture parameter set PPS.

pps_colour_space_boundary_luma_qp_offset indicates an offset value subtracted from QPP_Y that is a quantization parameter for luminance Y of the picture. pps_colour_space_boundary_cb_qp_offset indicates an offset value subtracted from QPP_Cb that is a quantization parameter for chrominance Cb of the picture. pps_colour_space_boundary_cr_qp_offset indicates an offset value subtracted from QPP_Cr that is a quantization parameter for chrominance Cr of the picture. Note that each of the value of pps_colour_space_boundary_luma_qp_offset, the value of pps_colour_space_boundary_cb_qp_offset, and the value of pps_colour_space_boundary_cr_qp_offset may be a value ranging from 0 to +12.

The flag pps_slice_colour_space_boundary_qp_offsets_present_flag indicates whether slice_colour_space_boundary_luma_qp_offset. slice_colour_space_boundary_cb_qp_offset, and slice_colour_space_boundary_cr_qp_offset are present in a slice header SH associated with the picture parameter set PPS.

slice_colour_space_boundary_luma_qp_offset indicates an offset value subtracted from QPS_Y that is a quantization parameter for luminance Y of the slice. slice_colour_space_boundary_cb_qp_offset indicates an offset value subtracted from QPS_Cb that is a quantization parameter for chrominance Cb of the slice. slice_colour_space_boundary_cr_qp_offset indicates an offset value subtracted from QPS_Cr that is a quantization parameter for chrominance Cr of the slice. The value of slice_colour_space_boundary_luma_qp_offset, the value of slice_colour_space_boundary_cb_qp_offset, and the value of slice_colour_space_boundary_cr_qp_offset may be values ranging from 0 to +12.

Next, the syntax illustrated in (c) of FIG. 35 will be described. As illustrated in (c) of FIG. 35, the entropy coder 104 of the image coding apparatus 11′ codes a differential value slice_qp_delta of the quantization parameters as a coding parameter included in the slice header SH. In addition, it is determined whether the flag pps_slice_colour_space_boundary_qp_offset_present_flag indicates that there is an offset to a quantization parameter for a block included in a boundary region of a color space. Then, in a case that the flag pps_slice_colour_space_boundary_qp_offset_present_flag indicates that there is the offset to the quantization parameter for the block included in the boundary region of the color space, the entropy coder 104 codes each of the following flags as a coding parameter included in the slice header SH.
colour_space_boundary_luma_qp_offset
colour_space_boundary_luma_qp_offset
colour_space_boundary_luma_qp_offset

Meanwhile, on the decoding side, before step S10 described above, the entropy decoder 301 decodes the flag pps_slice_colour_space_boundary_qp_offsets_present_flag, to determine whether the flag indicates that slice_colour_space_boundary_luma_qp_offset, slice_colour_space_boundary_cb_qp_offset, and slice_colour_space_boundary_cr_qp_offset are present in the slice header SH associated with the picture parameter set PPS (in a case that the flag is 1, the flag indicates that each offset value is present in the slice header SH, and in a case that the flag is 0, the flag indicates that each offset value is not present in the slice header SH).

Then, in a case that the flag indicates that slice_colour_space_boundary_luma_qp_offset, slice_colour_space_boundary_luma_qp_offset and slice_colour_space_boundary_luma_qp_offset are present in the slice header SH associated with the picture parameter set PPS, the entropy decoder 301 decodes the offset value colour_space_boundary_luma_qp_offset, the offset value colour_space_boundary_cb_qp_offset, and the offset value colour_space_boundary_cr_qp_offsetincluded in the slice header SH. Then, after step S10 described above, in the above-described step S11, the quantization parameter generation processing unit 3132 configures the quantization parameter for the block included in the boundary region determined by the color space boundary determination unit 3131 to a value obtained by subtracting the corresponding offset value among the above offset values from the quantization parameter QP1 (value derived based on the difference value slice_qp_delta) for a block included in a region other than the boundary region. Here, the QP1 is the QPP and QPS described above.

Next, the syntax illustrated in (d) of FIG. 35 will be described. As illustrated in (d) of FIG. 35, the entropy coder 104 of the image coding apparatus 11′ determine whether the flag colour_space_boundary_qp_offset_enabled_flag indicates that an offset is to be applied to the quantization parameter for the block included in the boundary region of the color space of a CTU (a quantization unit). Then, in a case that the flag colour_space_boundary_qp_offset_enabled_flag indicates that an offset is to be applied to the quantization parameter, the entropy coder 104 codes the flag colour_space_boundary_flag as a coding parameter for the CTU. The flag colour_space_boundary_flag is boundary region information indicating whether the pixel value of the target block is a block included in the boundary region of the color space.

Meanwhile, on the decoding side, for example, in step 50 described above, the entropy decoder 301 decodes the flag colour_space_boundary_flag. Next, in step S1 described above, the inverse quantization and inverse transform processing unit 311 determines whether the flag colour_space_boundary_flag decoded by the entropy decoder 301 indicates that the block indicated by the source image signal (CTU) is included in the boundary region of the color space. Next, in a case that the flag colour_space_boundary_flag indicates that the pixel value of the source target block is included in the boundary region of the color space, the inverse quantization and inverse transform processing unit 311 performs inverse quantization on blocks included in the boundary region by using the quantization parameter QP2 having a different value from the quantization parameter QP1 for the blocks included in the other region. More specifically, for example, in a case that the flag colour_space_boundary_flag indicates 1, the inverse quantization and inverse transform processing unit 311 performs inverse quantization by using the quantization parameter QP2 from which an offset value has been subtracted, the offset value being defined in the picture parameter set PPS or the slice header SH.

Note that in a case that whether the target block is included in the boundary region is determined using the decoded image of the neighboring block or the prediction image of the target block, coding and decoding of the flag colour_space_boundary_flag are not necessary.

### Summary of Embodiments

As described above, the video decoding apparatus (the image decoding apparatus 31′) according to the present embodiment is a video decoding apparatus that performs inverse quantization on a target block based a quantization parameter, the video decoding apparatus including a configuration unit (the color space boundary region quantization parameter information generation unit 313) configured to configure the quantization parameter for each quantization unit, in which the configuration unit configures, among a plurality of the target blocks, a quantization parameter for a block included in a boundary region of a color space to a value different from a quantization parameter for a block included in a region other than the boundary region.

According to the above-described configuration, by applying an appropriate quantization parameter to the block included in the boundary region to perform inverse quantization with high accuracy, it is possible to prevent the pixel value from having an error and to reduce the possibility of being included in a range that does not exist in the source image. Thus, the degradation of image quality caused by the presence of a pixel value with an error in the color space can be prevented.

In addition, the video coding apparatus (the image coding apparatus 11′) according to the present embodiment is a video coding apparatus that performs quantization or inverse quantization on a target block based a quantization parameter, the video coding apparatus including a configuration unit (the color space boundary region quantization parameter information generation unit 114) configured to configure the quantization parameter for each quantization unit, in which the configuration unit configures, among a plurality of the target blocks, a quantization parameter for a block included in a boundary region of a color space to a value different from a quantization parameter for a block included in a region other than the boundary region.

According to the above-described configuration, by applying an appropriate quantization parameter to the block included in the boundary region to perform quantization or inverse quantization with high accuracy, it is possible to prevent the pixel value from having an error and to reduce the possibility of being included in a range that does not exist in the source image. Thus, the degradation of image quality caused by the presence of a pixel value with an error in the color space can be prevented.

### Application Examples

The above-described image coding apparatuses 11 and 11′ and image decoding apparatuses 31 and 31′ can be utilized being installed in various kinds of apparatuses performing transmission, reception, recording, and reconstruction of video. Note that, the video may be a natural video imaged by camera or the like, or may be an artificial video (including CG and GUI) generated by computer or the like.

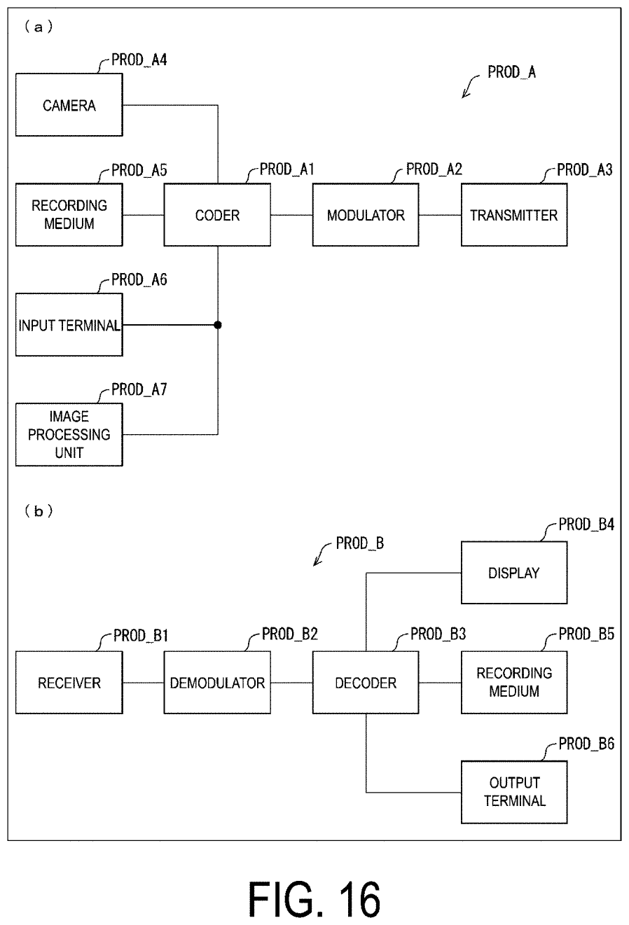

First, the above-described image coding apparatuses 11 and 11′ and image decoding apparatuses 31 and 31′ used for transmission and reception of videos will be described with reference to FIG. 16.

(a) of FIG. 16 is a block diagram illustrating a configuration of a transmitting apparatus PROD_A in which the image coding apparatuses 11 and the 11′ are installed. As illustrated in (a) of FIG. 16, the transmitting apparatus PROD_A includes an coder PROD_A1 which obtains coded data by coding videos, a modulation unit PROD_A2 which obtains modulation signals by modulating carrier waves with the coded data obtained by the coder PROD_A1, and a transmitter PROD_A3 which transmits the modulation signals obtained by the modulation unit PROD_A2. The above-described image coding apparatuses 11 and 11′ are used as the coder PROD_A1.

The transmitting apparatus PROD_A may further include a camera PROD_A4 that images videos, a recording medium PROD_A5 that records videos, an input terminal PROD_A6 for inputting videos from the outside, and an image processing unit A7 which generates or processes images, as supply sources of videos to be input into the coder PROD_A1. Although an example configuration in which the transmitting apparatus PROD_A includes all of the constituents is illustrated in (a) of FIG. 16, some of the constituents may be omitted.

Note that the recording medium PROD_A5 may record videos which are not coded or may record videos coded in a coding scheme for recording different from a coding scheme for transmission. In the latter case, a decoder (not illustrated) to decode coded data read from the recording medium PROD_A5 according to the coding scheme for recording may be present between the recording medium PROD_A5 and the coder PROD_A1.

(b) of FIG. 16 is a block diagram illustrating a configuration of a receiving apparatus PROD_B in which the image decoding apparatuses 31 and 31′ are installed. As illustrated in (b) of FIG. 16, the receiving apparatus PROD_B includes a receiver PROD_B1 that receives modulation signals, a demodulation unit PROD_B2 that obtains coded data by demodulating the modulation signals received by the receiver PROD_B1, and a decoder PROD_B3 that obtains videos by decoding the coded data obtained by the demodulation unit PROD_B2. The above-described image decoding apparatuses 31 and 31′ are used as the decoder PROD_B3.

The receiving apparatus PROD_B may further include a display PROD_B4 that displays videos, a recording medium PROD_B5 for recording the videos, and an output terminal PROD_B6 for outputting the videos to the outside, as supply destinations of the videos to be output by the decoder PROD_B3. Although an example configuration that the receiving apparatus PROD_B includes all of the constituents is illustrated in (b) of FIG. 16, some of the constituents may be omitted.

Note that the recording medium PROD_B5 may record videos which are not coded, or may record videos which are coded in a coding scheme for recording different from a coding scheme for transmission. In the latter case, a coder (not illustrated) that codes videos acquired from the decoder PROD_B3 according to the coding scheme for recording may be present between the decoder PROD_B3 and the recording medium PROD_B5.

Note that a transmission medium for transmitting the modulation signals may be a wireless medium or may be a wired medium. In addition, a transmission mode in which the modulation signals are transmitted may be a broadcast (here, which indicates a transmission mode in which a transmission destination is not specified in advance) or may be a communication (here, which indicates a transmission mode in which a transmission destination is specified in advance). That is, the transmission of the modulation signals may be realized by any of a wireless broadcast, a wired broadcast, a wireless communication, and a wired communication.

For example, a broadcasting station (e.g., broadcasting equipment)/receiving station (e.g., television receiver) for digital terrestrial broadcasting is an example of the transmitting apparatus PROD_A/receiving apparatus PROD_B for transmitting and/or receiving the modulation signals in the wireless broadcast. In addition, a broadcasting station (e.g., broadcasting equipment)/receiving station (e.g., television receivers) for cable television broadcasting is an example of the transmitting apparatus PROD_A/receiving apparatus PROD_B for transmitting and/or receiving the modulation signals in the wired broadcast.

In addition, a server (e.g., workstation)/client (e.g., television receiver, personal computer, smartphone) for Video On Demand (VOD) services, video hosting services and the like using the Internet is an example of the transmitting apparatus PROD_A/receiving apparatus PROD_B for transmitting and/or receiving the modulation signals in communication (usually, any of a wireless medium or a wired medium is used as a transmission medium in LAN, and the wired medium is used as a transmission medium in WAN). Here, personal computers include a desktop PC, a laptop PC, and a tablet PC. In addition, smartphones also include a multifunctional mobile telephone terminal.

A client of a video hosting service has a function of coding a video imaged with a camera and uploading the video to a server, in addition to a function of decoding coded data downloaded from a server and displaying on a display. Thus, the client of the video hosting service functions as both the transmitting apparatus PROD_A and the receiving apparatus PROD_B.

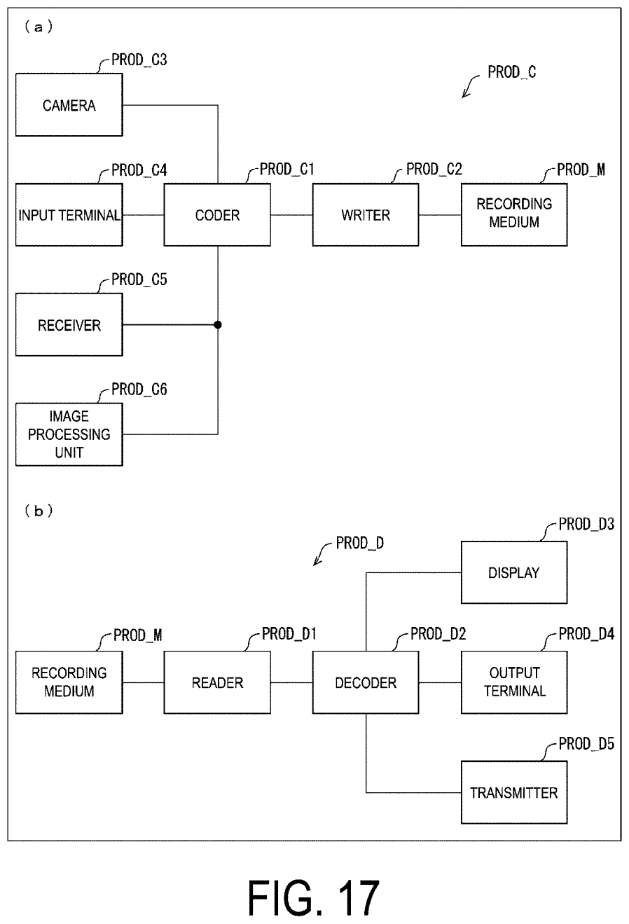

Next, the above-described image coding apparatuses 11 and 11′ and the image decoding apparatus 31 and 31′ used for recording and reconstruction of videos will be described with reference to FIG. 17.

(a) of FIG. 17 is a block diagram illustrating a configuration of a recording apparatus PROD_C in which the above-described image coding apparatuses 11 and 11′ are installed. As illustrated in (a) of FIG. 17, the recording apparatus PROD_C includes an coder PROD_C₁ that obtains coded data by coding a video, and a writing unit PROD_C2 that writes the coded data obtained by the coder PROD_C1 in a recording medium PROD_M. The above-described image coding apparatuses 11 and 11′ are used as the coders PROD_C₁.

Note that the recording medium PROD_M may be (1) a type of recording medium built in the recording apparatus PROD_C such as Hard Disk Drive (HDD) or Solid State Drive (SSD), may be (2) a type of recording medium connected to the recording apparatus PROD_C such as an SD memory card or a Universal Serial Bus (USB) flash memory, and may be (3) a type of recording medium loaded in a drive apparatus (not illustrated) built in the recording apparatus PROD_C such as Digital Versatile Disc (DVD) or Blu-ray Disc (BD: trade name).

In addition, the recording apparatus PROD_C may further include a camera PROD_C3 that images a video, an input terminal PROD_C4 for inputting the video from the outside, a receiver PROD_C5 for receiving the video, and an image processing unit PROD_C6 that generates or processes images, as supply sources of the video input into the coder PROD_C1. Although an example configuration that the recording apparatus PROD_C includes all of the constituents is illustrated in (a) of FIG. 17, some of the constituents may be omitted.

Note that the receiver PROD_C5 may receive a video which is not coded, or may receive coded data coded in a coding scheme for transmission different from the coding scheme for recording. In the latter case, a decoder for transmission (not illustrated) that decodes coded data coded in the coding scheme for transmission may be present between the receiver PROD_C5 and the coder PROD_C₁.

Examples of such recording apparatus PROD_C include, for example, a DVD recorder, a BD recorder, a Hard Disk Drive (HDD) recorder, and the like (in this case, the input terminal PROD_C4 or the receiver PROD_C5 is the main supply source of videos). In addition, a camcorder (in this case, the camera PROD_C3 is the main supply source of videos), a personal computer (in this case, the receiver PROD_C5 or the image processing unit C6 is the main supply source of videos), a smartphone (in this case, the camera PROD_C3 or the receiver PROD_C5 is the main supply source of videos), or the like is an example of the recording apparatus PROD_C as well.

(b) of FIG. 17 is block diagram illustrating a configuration of a reconstruction apparatus PROD_D in which the above-described image decoding apparatuses 31 and 31′ are installed. As illustrated in (b) of FIG. 17, the reconstruction apparatus PROD_D includes a reading unit PROD_D₁ which reads coded data written in the recording medium PROD_M, and a decoder PROD_D₂ which obtains a video by decoding the coded data read by the reader PROD_D₁. The above-described image decoding apparatuses 31 and 31′ are used as the decoders PROD_D₂.

Note that the recording medium PROD_M may be (1) a type of recording medium built in the reconstruction apparatus PROD_D such as HDD or SSD, may be (2) a type of recording medium connected to the reconstruction apparatus PROD_D such as an SD memory card or a USB flash memory, and may be (3) a type of recording medium loaded in a drive apparatus (not illustrated) built in the reconstruction apparatus PROD_D such as a DVD or a BD.

In addition, the reconstruction apparatus PROD_D may further include a display PROD_D₃ that displays a video, an output terminal PROD_D₄ for outputting the video to the outside, and a transmitter PROD_D₅ that transmits the video, as the supply destinations of the video to be output by the decoder PROD_D₂. Although an example configuration that the reconstruction apparatus PROD_D includes all of the constituents is illustrated in (b) of FIG. 17, some of the constituents may be omitted.

Note that the transmitter PROD_D₅ may transmit a video which is not coded or may transmit coded data coded in the coding scheme for transmission different from a coding scheme for recording. In the latter case, an coder (not illustrated) that codes a video in the coding scheme for transmission may be present between the decoder PROD D₂ and the transmitter PROD_D₅.

Examples of the reconstruction apparatus PROD_D include, for example, a DVD player, a BD player, an HDD player, and the like (in this case, the output terminal PROD_D₄ to which a television receiver, and the like are connected is the main supply destination of videos). In addition, a television receiver (in this case, the display PROD_D₃ is the main supply destination of videos), a digital signage (also referred to as an electronic signboard or an electronic bulletin board, and the like, and the display PROD_D₃ or the transmitter PROD_D₅ is the main supply destination of videos), a desktop PC (in this case, the output terminal PROD_D₄ or the transmitter PROD_D₅ is the main supply destination of videos), a laptop or tablet PC (in this case, the display PROD_D₃ or the transmitter PROD_D₅ is the main supply destination of videos), a smartphone (in this case, the display PROD_D₃ or the transmitter PROD_D₅ is the main supply destination of videos), or the like is an example of the reconstruction apparatus PROD_D.

### Realization by Hardware and Realization by Software

In addition, each block of the above-described image decoding apparatuses 31 and 31′ and the image coding apparatuses 11 and 11′ may be realized by hardware using a logical circuit formed on an integrated circuit (IC chip) or may be realized by software by using a Central processor (CPU).

In the latter case, each of the above-described apparatuses include a CPU that executes a command of a program to implement each of functions, a Read Only Memory (ROM) that stores the program, a Random Access Memory (RAM) to which the program is loaded, and a storage apparatus (recording medium), such as a memory, that stores the program and various kinds of data. In addition, an objective of the embodiments of the present disclosure can be achieved by supplying, to each of the apparatuses, the recording medium that records, in a computer readable form, program codes of a control program (executable program, intermediate code program, source program) of each of the apparatuses that is software for realizing the above-described functions and by reading and executing, by the computer (or a CPU or a MPU), the program codes recorded in the recording medium.

As the recording medium, for example, tapes including a magnetic tape, a cassette tape and the like, discs including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), cards such as an IC card (including a memory card)/an optical card, semiconductor memories such as a mask ROM/Erasable Programmable Read-Only Memory (EPROM)/Electrically Erasable and Programmable Read-Only Memory (EEPROM: trade name)/a flash ROM, logical circuits such as a Programmable logic device (PLD) and a Field Programmable Gate Array (FPGA), or the like can be used.

In addition, each of the apparatuses is configured to be connectable to a communication network, and the program codes may be supplied through the communication network. The communication network is required to be capable of transmitting the program codes, but is not limited to a particular communication network. For example, the Internet, an intranet, an extranet, a Local Area Network (LAN), an Integrated Services Digital Network (ISDN), a Value-Added Network (VAN), a Community Antenna television/Cable Television (CATV) communication network, a Virtual Private Network, a telephone network, a mobile communication network, a satellite communication network, and the like are available. In addition, a transmission medium constituting this communication network is also required to be a medium which can transmit a program code, but is not limited to a particular configuration or type of transmission medium. For example, a wired transmission medium such as Institute of Electrical and Electronic Engineers (IEEE) 1394, a USB, a power line carrier, a cable TV line, a telephone line, an Asymmetric Digital Subscriber Line (ADSL) line, and a wireless transmission medium such as infrared ray of Infrared Data Association (IrDA) or a remote control, BlueTooth (trade name), IEEE 802.11 wireless communication, High Data Rate (HDR), Near Field Communication (NFC), Digital Living Network Alliance (DLNA: trade name), a cellular telephone network, a satellite channel, a terrestrial digital broadcast network are available. Note that the embodiments of the present disclosure can be also realized in the form of computer data signals embedded in a carrier such that the transmission of the program codes is embodied in electronic transmission.

The embodiments of the present disclosure are not limited to the above-described embodiments, and various modifications are possible within the scope of the claims. That is, an embodiment obtained by combining technical means modified appropriately within the scope defined by claims is included in the technical scope of the present disclosure as well.

### CROSS-REFERENCE OF RELATED APPLICATION

This application claims the benefit of priority to JP 2017-189060 filed on Sep. 28, 2017, JP 2018-065878 filed on Mar. 29, 2018, and JP 2018-094933 filed on May 16, 2018, which are incorporated herein by reference in their entirety.

### INDUSTRIAL APPLICABILITY

The embodiments of the present disclosure can be preferably applied to an image decoding apparatus that decodes coded data in which image data is coded, and an image coding apparatus that generates coded data in which image data is coded.

### REFERENCE SIGNS LIST

1 Image transmission system
11, 11′ Image coding apparatus (video coding apparatus)
31, 31′ Image decoding apparatus (video decoding apparatus)
41 Image display apparatus
101, 308 Prediction image generation unit
102 Subtraction unit
103 Quantization processing unit
104 Entropy coder
105, 311 Inverse transform processing unit
106, 312 Addition unit
107, 305 Loop filter
108, 307 Prediction parameter memory
109, 306 Reference picture memory
110 Coding parameter determination unit
111 Prediction parameter coder
112 Inter prediction parameter coder
113 Intra prediction parameter coder
114, 313 Color space boundary region quantization parameter information generation unit (parameter generation unit)
301 Entropy decoder
302 Prediction parameter decoder
303 Inter prediction parameter decoder
304 Intra prediction parameter decoder
3050 Value limiting filter (value limiting filter apparatus)
3051, 3051′ Switch Unit
3052, 3052′ Color space transform processing unit (first transform processing unit)
3053, 3053′ Clipping processing unit (limiting unit)
3054, 3054′ Color space inverse transform processing unit (second transform processing unit)
3055a Cb/Cr signal upsampling processing unit (upsampling processing unit)
3055b Y Signal downsampling processing unit
3050a, 3050b, 3050c, 3050′ Value limiting filter processing unit (value limiting filter apparatus)
309, 1011 Inter prediction image generation unit
310 intra prediction image generation unit
10111, 3091 Motion compensation unit
10112, 3094 Weight prediction processing unit
3131 Color space boundary determination unit
31311 Y signal average value calculation unit
31312 Cb signal average value calculation unit
31313 Cr signal average value calculation unit
31314 RGB transform processing unit
31315 Boundary region determination processing unit
3132 Quantization parameter generation processing unit
3133 Color space boundary determination unit
31331 Y Signal limit value calculation unit
31332 Cb Signal limit value calculation unit
31333 Cr Signal limit value calculation unit

1. A value limiting filter apparatus comprising:
a first transform processing unit configured to transform an input image signal defined by a certain color space into an image signal of another color space;
a limiting unit configured to perform processing of limiting a pixel value on the image signal transformed by the first transform processing unit; and
a second transform processing unit configured to transform the image signal having the pixel value limited by the limiting unit into the image signal of the certain color space.

2. The value limiting filter apparatus according to claim 1, further comprising:
a switch unit configured to perform switching of whether to perform processing by the first transform processing unit, the limiting unit, and the second transform processing unit.

3. The value limiting filter apparatus according to claim 2,
wherein the switch unit performs the switching based on On/Off flag information determined based on a result of comparison between an error in a case that the processing by the first transform processing unit, the limiting unit, and the second transform processing unit is performed and an error in a case that the processing is not performed.

4. The value limiting filter apparatus according to claim 1, further comprising:
at least one of an upsampling processing unit configured to upsample a specific type of signal included in the input image signal and a downsampling processing unit configured to downsample a specific type of signal.

5. The value limiting filter apparatus according to claim 1,
wherein the first transform processing unit and the second transform processing unit performs calculation by multiplication, addition, and shift operation of integers in transform processing for transforming a color space.

6. The value limiting filter apparatus according to claim 1,
wherein, in a case that the input image signal indicates an image other than a monochrome image, the limiting unit performs processing of limiting a pixel value for only an image signal indicating chrominance in the input image signal.

7. The value limiting filter apparatus according to claim 1,
wherein the limiting unit performs the limiting based on whether the pixel value of the image signal transformed by the first transform processing unit is included in a color space formed using four points that are predetermined.

8. The value limiting filter apparatus according to claim 7,
wherein the color space formed using the four points is a parallelepiped.

9. The value limiting filter apparatus according to claim 7,
wherein the four points are points indicating black, red, green, and blue.

10. A video coding apparatus comprising the value limiting filter apparatus according to claim 1.

11. A video decoding apparatus comprising the value limiting filter apparatus according to claim 1.

12. A video decoding apparatus that performs inverse quantization on a target block based on a quantization parameter, the video decoding apparatus comprising:
a configuration unit configured to configure the quantization parameter for each quantization unit,
wherein the configuration unit configures, among a plurality of the target blocks, a quantization parameter for a block included in a boundary region of a color space to a value different from a quantization parameter for a block included in a region other than the boundary region.

13. The video decoding apparatus according to claim 12, further comprising:
an offset value decoder configured to decode an offset value,
wherein the configuration unit calculates the quantization parameter for the block included in the boundary region of the color space by subtracting the offset value from the quantization parameter for the block included in the region other than the boundary region.

14. The video decoding apparatus according to claim 12,
wherein the quantization parameter for the block included in the boundary region of the color space is calculated with reference to a table indicating the quantization parameter for the block included in the boundary region of the color space, the quantization parameter corresponding to the quantization parameter for the block included in the region other than the boundary region.

15. The video decoding apparatus according to claim 12, further comprising:
a boundary region information decoder configured to decode boundary region information and color space boundary region quantization parameter information indicating whether the target block is a block included in the boundary region of the color space,
wherein, in a case that the boundary region information indicates that the target block is included in the boundary region of the color space, the configuration unit configures the quantization parameter for the block included in the boundary region to the quantization parameter derived using the color space boundary region quantization parameter information.

16. The video decoding apparatus according to claim 12, further comprising:
a determination unit configured to determine whether the target block is included in the boundary region of the color space,
wherein, in a case that the determination unit determines that the target block is included in the boundary region of the color space, the configuration unit configures the quantization parameter for the block included in the boundary region to the value different from the quantization parameter for the block included in the region other than the boundary region.

17. The video decoding apparatus according to claim 16,
wherein the determination unit determines, with reference to a decoded block around a target quantization unit, whether the block included in the target quantization unit is the block included in the boundary region of the color space.

18. The video decoding apparatus according to claim 16,
wherein an image including the target block to be determined by the determination unit is a prediction image of the quantization unit.

19. The video decoding apparatus according to claim 16,
wherein the determination unit determines, with reference to a decoded image signal with target luminance, a decoded chrominance signal around a target quantization unit, or a chrominance signal of a prediction image, whether the pixel value included in the quantization unit is the pixel value of a chrominance signal included in a boundary region of the color space.

20-23. (canceled)

24. A video coding apparatus that performs quantization or inverse quantization on a target block based on a quantization parameter, the video coding apparatus comprising:
a configuration unit configured to configure the quantization parameter for each quantization unit,
wherein the configuration unit configures, among a plurality of the target blocks, a quantization parameter for a block included in a boundary region of a color space to a value different from a quantization parameter for a block included in a region other than the boundary region.
